(19) United States
(12) Patent Application Publication
(10) Pub. No.: US 2014/0016854 A1
(43) Pub. Date: Jan. 16, 2014

(54) PATTERN MATCHING DEVICE AND COMPUTER PROGRAM

(71) Applicants: Wataru Nagatomo, Tokyo (JP); Yuichi Abe, Tokyo (JP); Keisuke Nakashima, Tokyo (JP)

(72) Inventors: Wataru Nagatomo, Tokyo (JP); Yuichi Abe, Tokyo (JP); Keisuke Nakashima, Tokyo (JP)

(73) Assignee: HITACHI HIGH-TECHNOLOGIES CORPORATION, Tokyo (JP)

(21) Appl. No.: 14/001,376

(22) PCT Filed: Dec. 12, 2011
(86) PCT No.: PCT/JP2011/006906

§ 371 Date: Oct. 4, 2013

(30) Foreign Application Priority Data
Feb. 25, 2011 (JP) 2011-039187

(51) Int. Cl. G06T 7/00

(52) U.S. Cl. CPC G06T 7/001
USPC 382/149

(57) ABSTRACT

The present invention aims at providing a pattern matching device that conducts pattern matching on an image including a plurality of regions having different features with high precision, such as a pattern image including a plurality of layers.

In order to achieve the above object, the present invention proposes a pattern matching device that executes pattern matching on a target image with the use of a template formed on the basis of design data or a picked-up image, which executes the pattern matching on a first target image with the use of a first template including a plurality of different patterns, creates a second target image with the exclusion of information on a region including a specific pattern from the first target image, and determines the degree of similarity between the second target image, and a second template including pattern information other than the specific pattern.

### TECHNICAL FIELD

The present invention relates to a pattern matching device and a computer program, and more particularly to a pattern matching device and a computer program which conduct pattern matching on an image including a plurality of feature regions within the image with the use of a template formed on the basis of design data of a semiconductor device and a picked-up image.

### BACKGROUND ART

In a device that measures and inspects a pattern formed on a semiconductor wafer, a view field of an inspection device is adjusted to a desired measurement position through a template matching technique (Nonpatent Literature 1). Patent Literature 1 discloses an example of the above template matching method. The template matching represents processing of finding a region that most matches a template image registered in advance from an image to be searched. As an example of the inspection device using the template matching, there is measurement of the pattern on the semiconductor wafer with the use of a scanning electron microscope.

In this device, the view field of the device travels to a rough position of the measurement position by the movement of a stage. However, a large deviation is frequently produced on the image picked up by a high-power electron microscope only with a positioning precision of the stage.

Also, the wafer is not always placed on the stage in the same direction every time, and a coordinate system (for example, a direction along which chips of the wafer are aligned) of the wafer placed on the stage is not completely aligned with a driving direction of the stage, which also causes a deviation on the image picked up by the high-power electron microscope. Further, in order to obtain the image of the high-power electron microscope at a desired observation position, a target position on an observation specimen (also called “beam shift”) may be irradiated with an electron beam deflected by a fine amount (for example, several tens μm or lower). However, even in the beam shift, the irradiated position may be deviated from the desired observation position only with a precision in a deflection control of the beam. In order to correct the above respective deviations to conduct the measurement and inspection at an accurate position, template matching is conducted.

Specifically, alignment is conducted by an optical camera lower in power than the electron microscope image, and alignment is conducted on the electron microscope. Thus, alignment is conducted at a multistage. For example, when the alignment in the coordinate system of the wafer placed on the stage is conducted by the optical camera, the alignment is conducted with the use of images of a plurality of chips (for example, chips on both of right and left ends of the wafer) located distant from each other on the wafer. First, a unique identical pattern within the respective chips, or adjacent thereto (a pattern located relatively at the same position within the respective chips) is registered as a template (the pattern used in registration is frequently created as an optical alignment pattern on the wafer). Then, the stage travels so that the respective chips image the template-registered pattern to acquire the image by the respective chips. The template matching is conducted on the acquired image. The amount of deviation of the stage movement is calculated on the basis of the respective matching positions resultantly obtained, and the coordinate system of the stage movement and the coordinate system of the wafer match each other with the amount of deviation as a correction value of the stage movement. Also, in the alignment by the electronic microscope to be subsequently conducted, a unique pattern close to the measurement position is registered in the template in advance, and relative coordinates of the measurement position viewed from the template is stored in advance.

Then, when the measurement position is obtained from the image picked up by the electronic microscope, template matching is conducted in the picked-up image, the matching position is determined, and the relative coordinates stored in advance are moved from the determined matching position to obtain the measurement position. The view field of the device is moved to the desired measurement position with the use of the above template matching.

Also, Patent Literature 2 discloses a method of creating a template for template matching on the basis of the design data of the semiconductor device. If the template can be created on the basis of the design data, there is advantageous in that time and effort for purposely acquiring the image by the inspection device for template creation are eliminated.

Patent Literature 3 has proposed a method in which an influence of a lower layer is removed with separation into an upper layer and the lower layer to improve a matching performance.

Patent Literature 4 discloses a technique in which, in matching processing between a template formed on the basis of the design data and the image, the design data is subjected to exposure simulation so as to complement a configuration difference between the template and the image.

### CITATION LIST

### Patent Literature

[Patent Literature 1] Japanese Patent Publication No. 2001-243906 (corresponding U.S. Pat. No. 6,627,888)

[Patent Literature 2] Japanese Patent Publication No. 2002-328015 (corresponding U.S. Patent No. US2003/0173516)

[Patent Literature 3] WO2010/038859

[Patent Literature 4] Japanese Patent Publication No. 2006-126532 (corresponding U.S. Patent No. US2006/0108524)

### Nonpatent Literature

[Nonpatent Literature 1] New Edition, Image Analysis Handbook, supervision of TAKAGI, Mikio, University of Tokyo Press (2004)

### SUMMARY OF INVENTION

### Technical Problem

As compared with the creation of the template based on the picked-up image, and the creation of a pseudo-template disclosed in Patent Literature 1, according to the technique of creating the template with the use of the design data as disclosed in Patent Literatures 2, 3, and 4, there is advantageous in that operation for acquiring the image by the electronic microscope for the template creation, and the condition setting for the pseudo-template creation do not need to be conducted.

However, the design data represents an idle pattern configuration and arrangement state of the semiconductor device, which is different in hue from the image to be subjected to the template matching. In particular, with higher integration of the semiconductor device in recent years, the pattern is being multi-layered. However, the pattern of one layer may be different in hue from the pattern of another layer in view of a situation of the detection efficiency of secondary electrons emitted from the specimen. As described above, the design data represents the ideal configuration and arrangement of the pattern, and it may be difficult to conduct the appropriate matching between the design data and a target image different in hue of the pattern between the respective layers. Also, even if the template is created on the basis of the picked-up image, the hue may be different between the respective layers according to optical conditions of the imaging device (for example, scanning electronic microscope).

Patent Literature 3 discloses a technique in which templates of an upper portion and a lower portion of a hole pattern are created, separately, and matching is conducted by the respective templates. This publication discloses a matching method effective to a pattern such as the hole pattern in which edges are present in both of a lateral direction (X-direction) and a longitudinal direction (Y-direction). However, for example, if the upper layer pattern represents a line pattern extending, for example, inane direction, or a pattern in which lines extending in the same direction are arrayed at the same pitch, an accurate position may not be specified by the template of only the upper layer pattern.

Hereinafter, a description will be given of a pattern matching device intended to conduct pattern matching on an image including a plurality of regions having different features with high precision as with the pattern image including a plurality of layers, a computer program causing a computer to execute the processing in question, and a readable storage medium that stores the program in question.

### Solution to Problem

As one configuration for achieving the above object, thereinafter, there is proposed a pattern matching device, a computer program, or a readable storage medium storing the program in question, which executes pattern matching on an image with the use of a template formed on the basis of design data or a picked-up image, which executes the pattern matching on a first target image with the use of a first template including a plurality of different patterns, creates a second target image with the exclusion of information on a region including a specific pattern among a plurality of target patterns from the first target image, or with the reduction of the information on the specific pattern, and determines the degree of similarity between the second target image, and a second template including pattern information other than the specific pattern, or reducing the information on the specific information, or the first template.

Also, there is proposed a pattern matching device, a computer program, or a readable storage medium storing the program in question, which extracts position candidates of the pattern matching by pattern matching the first target image, and extracts a specific position from the candidates on the basis of the similarity determination.

### Advantageous Effects of Invention

According to the above configuration, even if the patterns having different features are mixed together within a search screen by pattern matching, a success rate of the pattern matching can be maintained in a high state.

### BRIEF DESCRIPTION OF DRAWINGS

FIG. 1 is a block diagram illustrating a process for pattern matching a template produced on the basis of design data, and an image.

FIG. 2 is a diagram illustrating the pattern matching process.

FIG. 3 is a diagram illustrating a process of removing an edge region having a high strength of a matching candidate to evaluate the degree of similarity.

FIG. 4 is a diagram illustrating one example of a process for selecting a high strength similarity region.

FIG. 5 is a diagram illustrating one example of a process for removing the high strength similarity region.

FIG. 6 is a diagram illustrating another example of a process for removing the high strength similarity region.

FIG. 7 is a diagram illustrating another example of a process for selecting the high strength similarity region.

FIG. 8 is a diagram illustrating an example of an inspection device that conducts template matching.

FIG. 9 is a block diagram illustrating a process of pattern matching the template produced on the basis of the design data, and the image.

FIG. 10 is a diagram illustrating a technique for treating a high strength similarity region.

FIG. 11 is a block diagram illustrating a process of pattern matching the template produced on the basis of the design data, and the image.

FIG. 12 is a diagram illustrating a technique for processing and removing the high strength similarity region.

FIG. 13 is a diagram illustrating an example of a GUI screen for setting template matching conditions.

FIG. 14 is a schematic diagram of a measurement and inspection system including an SEM.

FIG. 15 is a diagram illustrating a creation example of a similarity determination image on the basis of region selection of an SEM image.

FIG. 16 is a flowchart illustrating a process for determining a matching position on the basis of a plurality of pattern matching processing.

FIG. 17 is a flowchart illustrating a process for determining the matching position on the basis of the plurality of pattern matching processing.

### DESCRIPTION OF EMBODIMENTS

Hereinafter, a description will be mainly given of pattern matching using a template formed on the basis of design data.

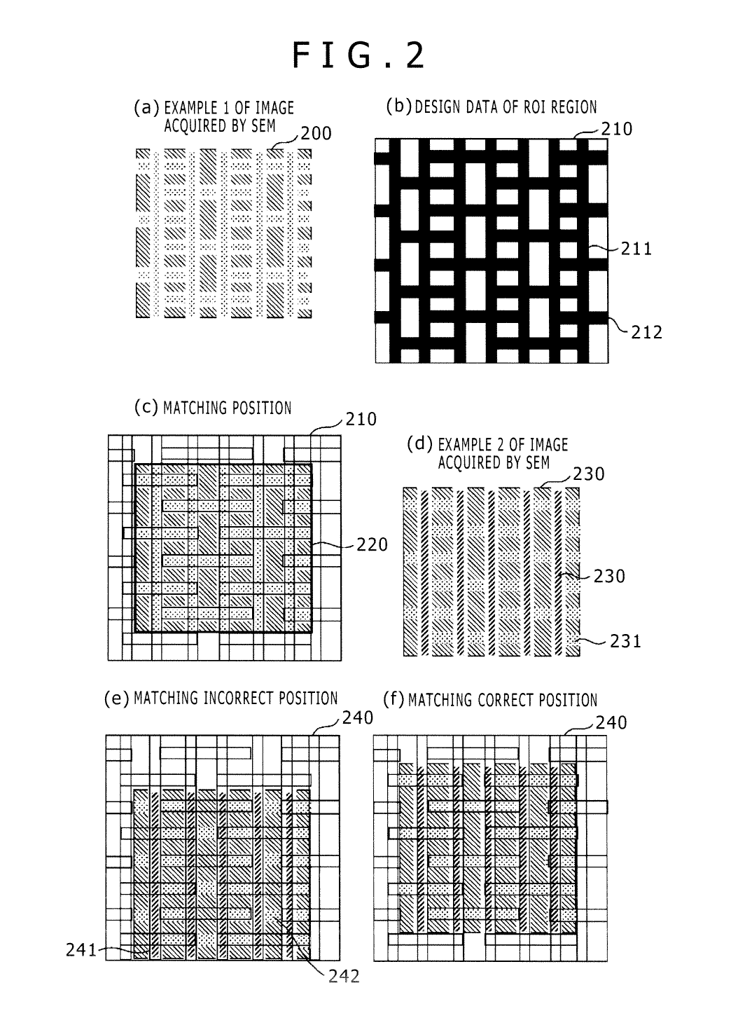

FIGS. 2A, 2B, and 2C illustrate an example of matching an image (hereinafter called “SEM image”) picked up by a scanning electron microscope (SEM), and a template formed on the basis of design data. In order to conduct matching processing, the design data is subjected to given processing so as to be imaged. A matching result when an SEM image 200 in FIG. 2A is an image to be searched, and design data 210 in FIG. 2B is a template is illustrated in FIG. 2C (in this example, an image size of the SEM image 200 is smaller than that of the design data 210, and a region of a pattern similar to that of the SEM image 200 is found from the design data 210).

In the design data 210 illustrated in FIG. 2C, since a region 220 is most similar to a pattern shape of the SEM image 200, the SEM image 200 is detected as a matching position. The result is that a region in which patterns completely match each other between both of those images can be detected, and the matching is successful (hereinafter, a position of a region where the matching is successful is called “matching correct position”). The SEM image and the design data may be different in contrast of the image from each other. However, processing of conducting edge extraction filtering may be conducted on the image for the purpose of evaluating the degree of similarity with the reduction of an influence of the difference between both of those images.

FIG. 2B illustrates that only a region necessary for matching is cut out as a part of the design data in the semiconductor device. The cutout region needs to have a size including a view field deviation range of the device. In the following description, this region is called “an ROI (region of interesting) region.

In the matching processing using the template formed on the basis of the design data, when a visual separation in the image at the matching correct position between the SEM image and the design data is large, the matching may fail. For example, when an observation specimen has a multilayered pattern, a pattern in a specific layer may become vague in the SEM image, and the matching may fail. As an example of the multilayered pattern, it is assumed that the design data 210 in FIG. 2B has a bilayer structure in which vertical lines 211 are in an upper layer, and lateral lines 212 are in a lower layer. In the SEM image, the amount of electrons complemented by a detector is different depending on a structure of the pattern or a material thereof, and a hue of the pattern may be different between the layers.

Hence, for example, as illustrated in FIG. 2D, the lower layer pattern becomes vague as compared with the upper layer pattern. In this case, the matching may fail for the following reason. When the matching fails, the above-mentioned alignment fails, resulting in a problem that the measurement and inspection processing cannot be conducted.

As illustrated in FIG. 2D, if an upper layer pattern 230 is distinct (for example, contrast is high), and a lower layer pattern 231 is vague (for example, contrast is low) , an edge strength of a region of the upper layer pattern is higher an edge strength of a region of the lower layer pattern. As a result, in evaluating the degree of similarity between the SEM image and the design data (for example, using a normalized correlation method), an influence of the upper layer pattern is larger than that of the lower layer pattern. Also, in the SEM image, a gradation value of the image is varied due to the roughness of a surface of the pattern, and noise caused by various factors.

The gradation value is varied even within only a region in which the edge strength of the upper layer pattern is higher (hereinafter called “high strength region”). When the variation is the same as or more than the edge strength of a region in which the edge strength of the lower layer pattern is lower, a difference in the degree of similarity between a matching incorrect position caused by the deviation of the lower layer pattern and the matching correct position is buried in a variation of the gradation value in the high strength region, and hardly appears in a similarity evaluation value.

In this case, if attention is paid to only an upper layer pattern 241 as indicated in a matching result 240 illustrated in FIG. 2E, the matching is successful (hereinafter, this region is called “high strength similarity region”), however, the matching position may be deviated in a lower layer pattern 242. FIG. 2F illustrates an example of a matching success position. In this example, a region in which the degree of similarity is highest is at the matching incorrect position, and the pattern in the high strength region is similar between the correct position and the incorrect position. Therefore, it is found that the matching correct positions are included in the higher candidates of the similarity evaluation in most of the cases. Although the details will be described later, in the following description, means for obtaining the matching correct position with the use of the information on the matching candidate is provided. In the above example, the lower layer pattern is vague. However, not only the lower layer, but also other layers such as the upper layer, and a specific pattern may become vague depending on a material or a structure thereof.

In the embodiment described below, a description will be given of a pattern matching device, a computer program that causes a computer to execute the pattern matching, and a computer readable storage medium storing the program, which achieve a high template success rate even when a high strength and a low strength of the gradation value or the edge strength are mixed together within a pattern to be searched mainly in the template matching.

One configuration for improving the success rate of the pattern matching includes a preprocessing unit that preprocesses an image to be searched; a preprocessing unit that preprocesses a template; a template matching processing unit that selects a plurality of matching candidate positions with the use of the image to be searched which has been preprocessed, and the template which has been preprocessed; a designation processing unit of a high strength similarity region which designates the high strength similarity region to be removed from the image to be searched from the design data of an ROI region; a removal processing unit of the high strength similarity region which removes a similarity region of the high strength from the image to be searched; a similarity determination processing unit that calculates the degree of similarity of the image from which the high strength similarity region has been removed, and the template; and a matching position selection processing unit that selects a matching position high in the degree of similarity.

A description will be given of the pattern matching device, the computer program that causes the computer to execute the pattern matching, and the computer readable storage medium storing the program, in which the similarity region of the high strength described above includes an overall region in which the pattern is present in the upper layer of the design data.

The above means evaluates the degree of similarity between each of plural matching candidate positions including the matching correct position and the matching incorrect position obtained by the template matching processing unit in a remaining region where the region of the high strength has been removed, and the template. Therefore, the above means evaluates the degree of similarity in only the region of the low strength without being influenced by the region of the high strength with the result that the matching correct position can be selected even in the above problematic case. In the matching processing unit, since the image including both of the high strength region and the low strength region is used, matching including the information on the low strength region is conducted with the result that the matching correct positions in which the positional deviation does not occur in the low strength region are included in the matching candidates.

According to the above-mentioned configuration, even when the high strength and the low strength of the gradation value or the edge strength are mixed together within the pattern to be searched, the accurate matching position can be determined by the temperate matching. Also, in the image including the multilayered pattern, it is conceivable that the pattern corresponding to the upper layer forms the high strength region, and the pattern corresponding to the lower layer forms the low strength region. When the upper layer and the lower layer are subjected to the matching processing, separately, the information on the lower layer pattern is excluded particularly in matching the upper layer. This may make it difficult to realize accurate matching. As exemplified in FIG. 2, when the upper layer pattern included within the image includes only a pattern elongated in a Y-direction (vertical direction) , if the information on the lower layer pattern is excluded, there is a possibility that not only the matching position in the Y-direction becomes vague, but also matching is conducted at positions displaced at n-pitches in the X-direction.

In an example described below, a description will be given of a pattern matching method in which matching can be conducted at a high success rate not depending on a difference in the edge strength between the upper layer and the lower layer while conducting matching with the use of the information on the multilayered pattern.

Hereinafter, a description will be given of a pattern matching processing with reference to the drawings. It is assumed that the same reference numerals denote identical members in the drawings unless otherwise specified.

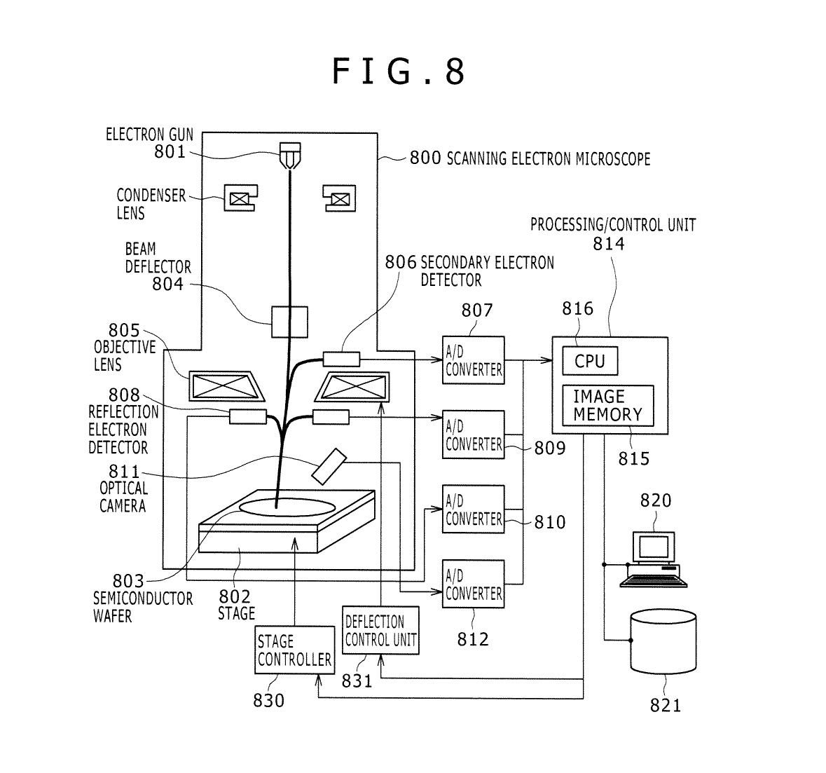

FIG. 8 is a diagram illustrating an example of the measurement or inspection device by which the pattern matching is executed in a measurement or inspection process. In this embodiment, a description will be given of a device that positions a view field of an electron beam to a desired measurement position by matching processing in a scanning electron microscope (SEM) that is mainly used in a pattern dimension measurement of a semiconductor device formed on a semiconductor wafer. The matching processing in this embodiment removes the high strength similarity region, and executes the similarity evaluation, mainly for the matching candidates on the image.

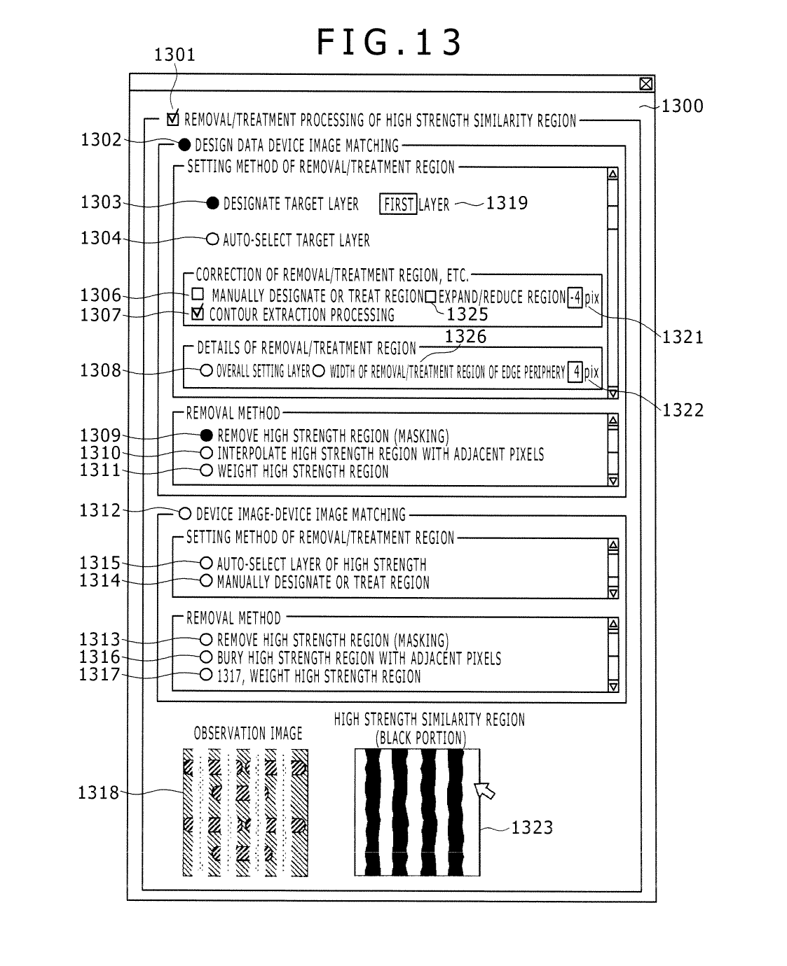

In the SEM, an electron beam is generated from an electron gun 801. A beam deflector 804 and an objective lens 805 are controlled so that the electron beam is emitted and focused at an arbitrary position on a semiconductor wafer 803 which is a specimen placed on a stage 802. Secondary electrons are emitted from the semiconductor wafer 803 irradiated with the electron beam, and detected by a secondary electron detector 806. The detected secondary electrons are converted into a digital signal by an A/D converter 807, stored in an image memory 815 within a processing/control unit 814, and subjected to image processing according to purposes by a CPU 816. The template matching according to this embodiment is processed by the processing/control unit. The setting of the processing described with reference to FIG. 13, and a display of the processing result are conducted by a display device 820. Also, in the alignment using an optical camera with a lower power than that of the electronic microscope, an optical camera 811 is used. A signal obtained by imaging the semiconductor wafer 803 by this camera is also converted into a digital signal by an A/D converter 812 (if the signal from the optical camera is a digital signal, the A/D converter 812 is unnecessary), stored in the image memory 815 within the processing/control unit 814, and subjected to the image processing according to the purposes by the CPU 816. Also, when a reflection electron detector 808 is provided, reflection electrons emitted from the semiconductor wafer are detected by the reflection electron detector 808, and the detected reflection electrons are converted into a digital signal by an A/D converter 809 or 810, stored in the image memory 815 within the processing/control unit 814, and subjected to the image processing according to the purposes by the CPU 816.

In this example, the scanning electron microscope exemplifies the inspection device. However, the present invention is not limited to this configuration, but can be applied to the inspection device that acquires the image, and conducts the template matching processing.

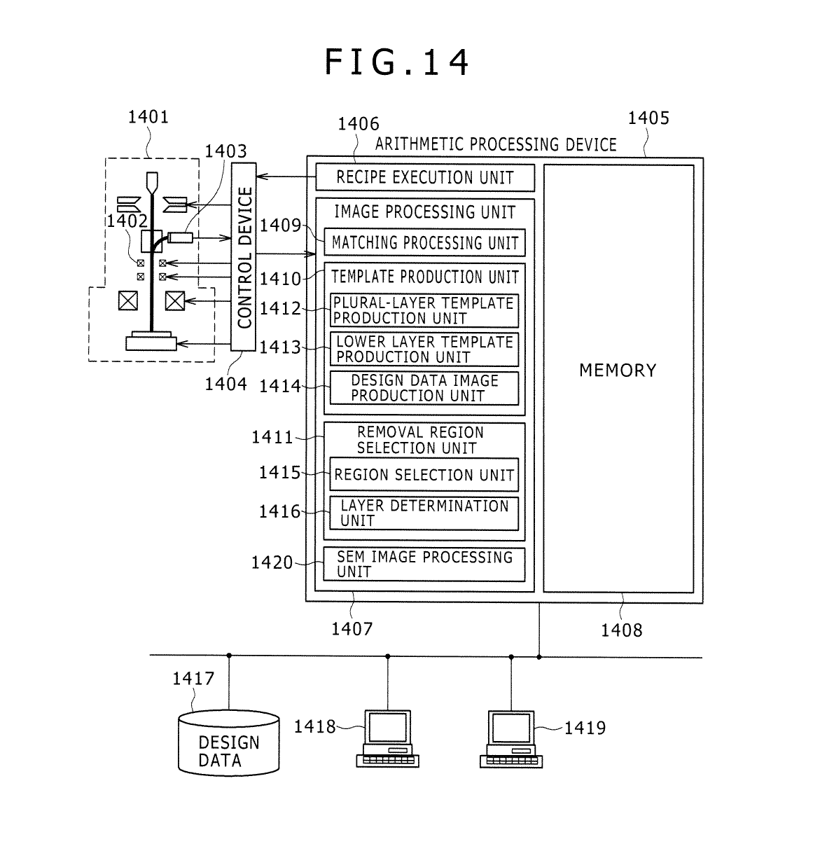

FIG. 14 is an illustrative view of the details of a measurement or inspection system including the SEM. This system includes an SEM main body 1401, a control device 1403 of the SEM main body, and an arithmetic processing device 1405. The arithmetic processing device 1405 includes a recipe execution unit 1406 that supplies a given control signal to the control device 1403, an image processing unit 1407 that conducts image processing of an image obtained by arraying detection signals obtained by the detector 1403 in synchronization with scanning of a scanning deflector 1402, and a memory 1408 that stores recipe information executed by the recipe execution unit 1406 therein.

The electrons emitted from the specimen is acquired by the detector 1403, and converted into a digital signal by an A/D converter incorporated into a control device 1404. The image processing is conducted according to the purpose by an image processing hardware such as a CPU, an ASIC, or an FPGA incorporated into the image processing unit 1407. Also, the image processing unit 1407 has a function of creating a line profile on the basis of a detection signal, and measuring a dimension between peaks of the profile.

Further, the arithmetic processing device 1405 is connected to an input device 1418 having input means, and has a function of a GUI (graphical user interface) that allows an image or an inspection result to be displayed on a display device provided in the input device 1418 for an operator.

A part or all of control and processing in the image processing unit 1407 can be allocated to an electronic computer having a CPU and a memory that can store an image therein, and processed and controlled. Also, the input device 1418 also functions as an imaging recipe creation device that creates an imaging recipe including coordinates of an electronic device required for inspection, a pattern matching template used for positioning, and photographing conditions, manually, or with the help of the design data stored in a design data storage medium 1417 of the electronic device.

The input device 1418 has a template creating unit that clips a part of a line image formed on the basis of the design data to create a template. The created template is registered in the memory 1408 as a template of the template matching in a matching processing unit 1409 incorporated into an image processing unit 507. The template matching represents a technique of specifying a portion where the picked-up image to be positioned matches the template on the basis of the degree of matching using a normalized correlation method, and the matching processing unit 1409 specifies a desired position of the picked-up image on the basis of the matching degree determination. In this embodiment, the degree of matching between the template and the image is expressed by words such as the degree of matching or the degree of similarity, which have the same meaning from the viewpoint of an index indicative of the extent of matching therebetween. Also, the degree of non-matching and the degree of dissimilarity also represent modes of the degree of matching and the degree of similarity.

The embodiment described below relates to the pattern matching between edge information obtained mainly on the basis of the design data, and the image picked up by the SEM or the like, and the edge information obtained on the basis of the design data includes line image information indicative of an ideal shape of the pattern formed on the basis of the design data, or line image information subjected to deformation processing so as to come close to a real pattern by a simulator 1419. Also, the design data is expressed by, for example, a GDS format or an OASIS format, and stored in a given format. Any kind of design data is applicable if software that displays the design data can display the format thereof , and deal with the design data as graphic data.

In the embodiment described below, a description will be given of an example in which the matching processing is executed by the control device mounted on the SEM, or the arithmetic processing device 1405 connected to the SEM through a communication line. However, the present invention is not limited to this configuration, but processing to be described later may be conducted by a computer program with the use of a general-purpose arithmetic device that executes the image processing by a computer program. Further, a technique to be described later is applicable to other charged particle radiation devices such as a focused ion beam (FIB) device.

This embodiment pertains to a device that conducts the pattern matching, a program causing a computer to execute the pattern matching, and a storage medium storing the program therein.

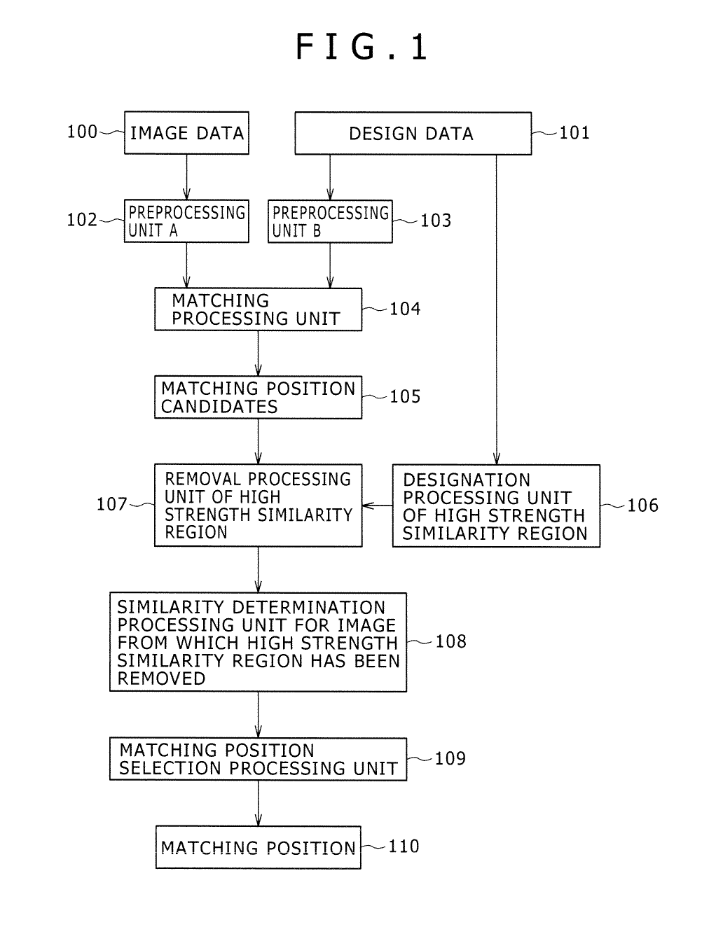

FIG. 1 is a block diagram illustrating a configuration of template matching processing in a pattern matching device included in the measurement and inspection device (hereinafter called merely “inspection device”) according to a first embodiment. Matching is conducted by image data 100 of a region to be searched acquired by the inspection device, and design data 101 of an ROI region clipped from the design data of the semiconductor device to finally calculate a matching position 110. This processing is executed by the matching processing unit 1409.

This embodiment is intended to detect the matching correct position even when the high strength (or a high value) and the low strength (or a low value) of the edge strength (or gradation value) are mixed together in the image to be searched as described above. To achieve this, the details will be described in a later half of the description in FIG. 1, and the similarity region in which the edge strength (or the gradation value) is the high strength (or high value) is removed from the image data in each of the plural matching position candidates obtained by the normal matching. The degree of similarity of the remaining region of the image data and the template is evaluated (for example, correlation operation (Nonpatent Literature 1, pp. 1672). Candidates having the high degree of similarity among the matching position candidates are output as the matching position.

As a result, even when the high strength (or the high value) and the low strength (or the low value) of the edge strength (or gradation value or the degree of similarity between the image to be searched and the template) of the pattern to be searched are mixed together, the matching result also taking the pattern of the region having the low strength (or the low value) into consideration can be obtained to obtain the matching correct position. In the present specification, the edge strength of the pattern will be mainly described below. However, the same matching can be implemented on a pixel value, or the degree of similarity between the image to be searched and the template by merely replacing the edge strength therewith.

Hereinafter, the respective processing of matching in FIG. 1 will be described. In preprocessing A102, processing for reducing an influence of noise included in the image on the matching processing is conducted. For example, noise reduction processing such as Gaussian filter processing or median filter processing (Nonpatent Literature 1, pp. 1670) is conducted as the processing. The noise reduction processing is not limited to this configuration, but any processing that can reduce the noise is applicable. Further, in order to emphasize the shape of the pattern, edge emphasis processing is conducted. For example, Sobel filter processing (Nonpatent Literature 1, pp. 1215) or the like is conducted. The edge emphasis processing is not also limited to this configuration, but any processing that can conduct the edge emphasis is applicable. Both processing of the noise reduction processing and the edge emphasis processing in the preprocessing of this preprocessing unit A is not always implemented, but any one processing or both of those processing may not be implemented. This image processing can be conducted by an SEM image processing unit 1420.

In a preprocessing unit B103, in order to emphasize the shape of the pattern of the design data, the edge emphasis processing is conducted. For example, the Sobel filter processing (Nonpatent Literature 1, pp. 1215) or the like is conducted. The edge emphasis processing is not limited to this configuration, but any processing that can conduct the edge emphasis is applicable. Also, this processing in a preprocessing unit B is not always implemented, but the processing may not be implemented. A template (first template) including information on a plurality of layers is produced on the basis of the above processing. The above image processing can be conducted by a design data image processing unit 1414 disposed in a template production unit 1410. Also, a plural-layer template production unit 1412 produces the template on the basis of plural layers of pattern data included in the selected design data region.

With the use of the first template produced as described above, a matching processing unit 104 or 1409 conducts the template matching on a target image (first target image) (Nonpatent Literature 1, pp. 1670). For example, the matching processing is conducted with a normalized correlation method (Nonpatent Literature 1, pp. 1672). Positions of regions in which the pattern is similar between the template and the image to be searched can be detected through the matching processing. The matching processing unit 104 selects a plurality of positions having the higher degree milarity (for example, correlation value). The number of selections may be set to a given value in advance, or the regions whose index of the incidence degree determination called “matching score” is a given value or more may be selected. Also, the number of regions indicative of the degree of incidence having a given value or more may be set to a given value (or a given number, or more) in advance.

The selected matching positions represent matching position candidates 105, and as described above, the matching position candidates 105 frequently include the matching correct positions and the matching incorrect positions

A designation processing unit 106 of the high strength similarity region designates regions in which the edge strength is high as described above. The high strength similarity region represents a region in which the degree of similarity between the template and the image to be searched is high, and the strength is high, a region in which the degree of similarity is high, and the strength is expected to be high, or a region including those regions (region including those regions in this case represents, for example, a region of a layer in which there is the design data including the region high in the similarity and high in the strength). Thus processing is conducted by a region selection unit of a removal processing selection unit 1411.

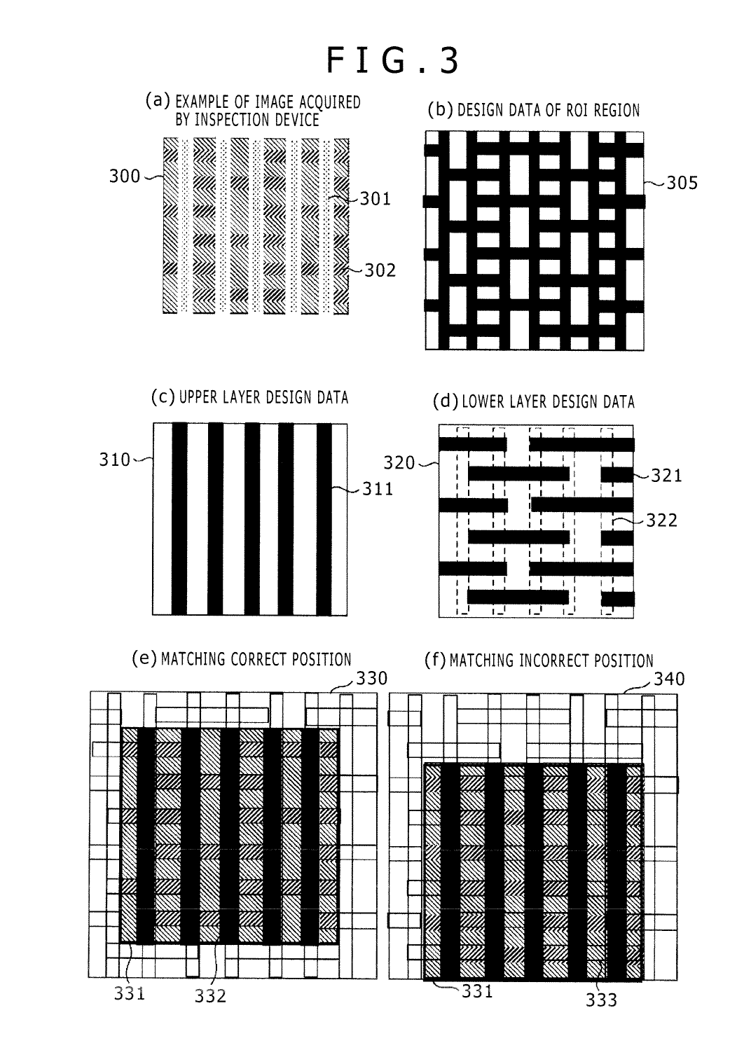

For example, as will be described with reference to FIG. 3 later, the design data of the upper layer pattern having the high strength is designated on the basis of the design data. A removal processing unit 107 of the high strength similarity region removes a region (upper layer pattern 311 in the example of FIG. 3) designated by the above designation processing unit 106 of the high strength similarity region from a region (region 300 in the example of FIG. 3) of the image data (image to be searched) corresponding to the respective matching position candidates, to thereby produce a second target image from which specific layer information has been excluded. This makes it possible to remove the region (pattern information of the specific layer) of the high strength described above. In this example, the image data may be an image that has been preprocessed in the preprocessing A102, or an image of the image data 100 acquired by the inspection device as it is. Further, the designation processing unit 106 of the high strength similarity region creates the template in which the lower layer pattern is selectively displayed on the basis of the above selection. A lower layer template production unit 1413 excludes the selection pattern on the basis of the selection of the upper layer pattern to create a template (second template) in which the lower layer pattern is selectively displayed.

Also, the above-mentioned high strength region or the low strength region may conduct automatic determination on the basis of layer information registered in GDS data. For example, the input device 1418 may set an image acquisition region on the design data, automatically discriminate which layer the pattern included in the acquisition region belongs , on the basis of the selection, and automatically discriminate patterns belonging to the upper layer side, and patterns belonging to the lower layer side. When the above processing is automatically conducted, a sequence for classification so that the pattern having the upper layer information is classified into the upper layer pattern, and the pattern having the lower layer information is classified into the lower layer pattern is prepared, and the patterns are automatically classified on the basis of the setting of the image acquisition region. The above processing may be executed by a layer determination unit 1415 on the basis of the selection in the removal processing selection unit 1411.

A similarity determination processing unit 108 for the image from which the high strength similarity region has been removed evaluates the degree of similarity for the image data (image 331 in the example of FIG. 3) obtained by the removal processing unit 107 of the above-mentioned high similarity region with the use of the pattern (lower layer pattern 321 in the example of FIG. 3) of the template (second template including the specific layer information) except for the removed region. This makes it possible to conduct the similarity evaluation in which the similarity region of the high intensity has been removed in the respective matching position candidates, and mainly makes it possible to conduct the similarity evaluation in the pattern of the low strength.

A matching position selection processing unit 109 compares the degree of similarities at the respective matching candidate positions at the respective matching candidate positions obtained by a similarity determination processing unit 108 for the image from which the above high strength similarity region has been removed with each other, and outputs a candidate highest in the degree of similarity as the matching position 110. With the above configuration, even when the high strength and the low strength of the edge strength of the pattern to be searched are mixed together in the pattern to be searched on the image to be searched, it is possible to determine an accurate matching position by the template matching. Because the above similarity determination may be selectively conducted on the extracted matching candidate positions, the precise matching position can be specified with a high efficiency. The above similarity determination can be applied with the above-mentioned matching algorithm, and can be conducted by the matching processing unit 1409. Also, the matching candidate position information is stored in the memory 1408 in advance, and the template of the lower layer pattern maybe superimposed on the image on the basis of the position information.

As described above, the matching candidate positions are narrowed by a first matching, and the selective degree of similarity of the lower layer pattern (low brightness region) is determined, thereby making it possible to conduct the high precision matching using the low brightness region relatively small in the amount of information on the high brightness region.

The above similarity determination is conducted with the use of the second template in which the lower layer pattern is selectively displayed. Alternatively, the similarity determination may be conducted with the use of the first template. In this case, because of a comparison between the second target image (image from which the upper layer image has been removed) and the first template (image including the upper layer information and the lower layer information), even if the accurate matching position is provided, the degree of similarity becomes relatively low as compared with the determination using the second template. On the other hand, because the second target image is an image from which the upper layer information has been removed, even if the information of the upper layer remains in the template, this may hardly influence relative merits of the degree of similarity among a plurality of matching position candidates. Hence, when the degree of similarity among the plurality of matching position candidates balances each other, and a precision in the matching is intended to be prioritized, it is conceivable that the similarity determination using the second template is conducted. When a processing efficiency is intended to be enhanced with the elimination of the processing for creating the second template, it is conceivable that the similarity determination using the first template is conducted.

FIG. 3 is a diagram illustrating a first method of removing the similarity region of the high strength on the basis of the design data 101 in the ROI region by the designation processing unit 106 of the high strength similarity region, the removal processing unit 107 of the high strength similarity region, and the similarity determination processing unit 108 for the image from which the high strength similarity region has been removed in FIG. 1 to conduct the similarity evaluation. FIG. 3A illustrates an example of an image 300 acquired by the inspection device. This image is an example in which a semiconductor device of the multilayer structure is observed, and has a double layer structure of the upper layer and the lower layer. A pattern 301 formed in the upper layer is higher in the gradation value of the image than a pattern 302 formed in the lower layer, and also higher in the strength of an edge of the pattern. Also, FIG. 3B illustrates design data 305 of the ROI region, which is the template image.

When the image to be searched is the region 300 in FIG. 3A, as described above, because the edge strength of the lower layer pattern 302 is lower than that of the upper layer pattern 301, the matching position is deviated, for example, in the lower layer pattern in the normal template matching whereby the matching correct position may not be obtained (the same reason as that in the example described in FIG. 2F). Therefore, the upper layer pattern high in the edge strength or high in the gradation value is removed.

FIGS. 3C and 3D illustrate design data 310 of the upper layer pattern, and design data 320 of the lower layer pattern in one of the matching position candidates described in FIG. 1. For example, when the edge strength of the upper layer pattern is high in an observation image of a semiconductor pattern of the multilayer structure as in the image 300 of FIG. 3A, the upper layer design data 310 is removed from the image 300, to thereby produce an image 331 from which the region of the high strength has been removed.

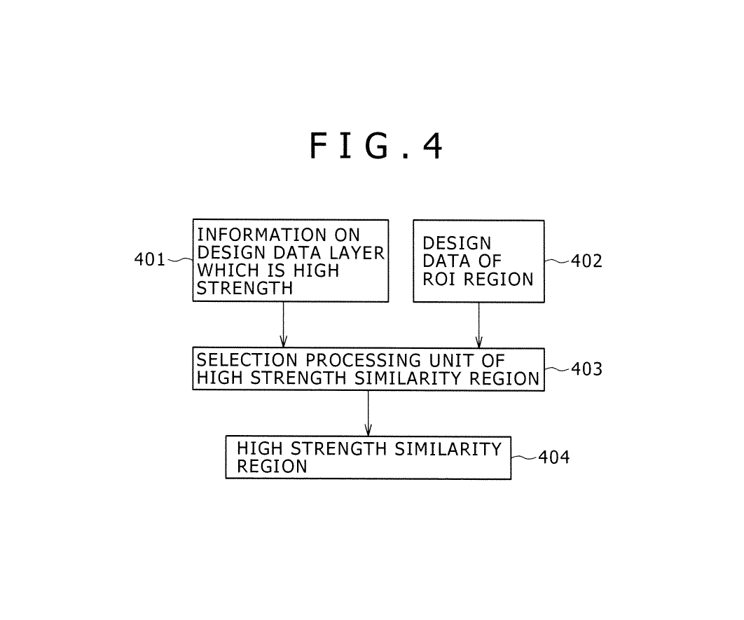

This removal processing is conducted by the removal processing unit 107 of the high strength similarity region. A method of designating the region to be removed will be described with reference to FIG. 4. For example, when it is found that the strength of the pattern in the upper layer is high from the viewpoint of the property of the observation image, there is, for example, a method in which the upper layer pattern is determined as a removal region in advance, or a method in which the removal pattern can be accepted from the user (an example of a GUI (graphical user interface) of the user setting will be described with reference to FIG. 13).

Then, the similarity evaluation is conducted on the image 331 from which the region of the high strength has been removed with the use of a pattern (in this example, lower layer design data 321) which is the design data other than the removed region (for example, using the normalized correlation value method). The similarity evaluation is conducted by the similarity determination processing unit 108. In this example, the similarity evaluation method is not limited to the normalized correlation method, but applicable to any method that can evaluate the degree of similarity. Also, when it is found that a part of the pattern is concealed from the pattern to be removed on the image in the pattern (pattern for conducting the similarity evaluation) which is the design data other than the above removed pattern, it is possible to use the pattern (removal of a portion that overlaps with a dashed region interior 322 in FIG. 3D) from which the concealed portion has been removed.

FIGS. 3E and 3F illustrate an example of a matching correct position 330, and a matching incorrect position 340 included in the matching candidates. In the correct position 330, the lower layer pattern of the image 300 substantially matches a lower layer pattern 332 of the design data. On the other hand, in the incorrect position 340, the lower layer pattern of the image 300 does not match a lower layer pattern 333 of the design data. With the removal of the region of the upper layer pattern which is the region of the high strength, the degree of similarity between the correct position 330 and the incorrect position 340 can be differentiated, and the degree of similarity at the correct position 330 in which there are many portions where the patterns match each other becomes high. Hence, the higher candidates are selected with the degree of similarity calculated in the similarity determination processing unit 108 to select the matching correct position.

Also, in this example, the upper layer pattern 301 is high in the strength, and the lower layer pattern 302 is low in the strength. However, the number of layers is not particularly limited to the two layers, and the region of the high strength is not also limited to the upper layer. In the design data of the multilayer structure, the layer of the region having the high strength is removed when the region of the high strength is provided, and the similarity determination processing is conducted by the remaining region.

FIG. 4 is a block diagram illustrating a configuration of a method for designating the high strength similarity region that is removed from the image data 100 by the designation processing unit 106 of the high strength similarity region in FIG. 1. As the method for designating the high strength similarity region, the following two examples will be described in the present specification. One of those methods is a method of extracting the high strength similarity region from the image picked up by the inspection device by image processing, and the other method is a method of acquiring information on the high strength similarity region from the image acquired by the inspection device or the property of an observation specimen before the image is acquired.

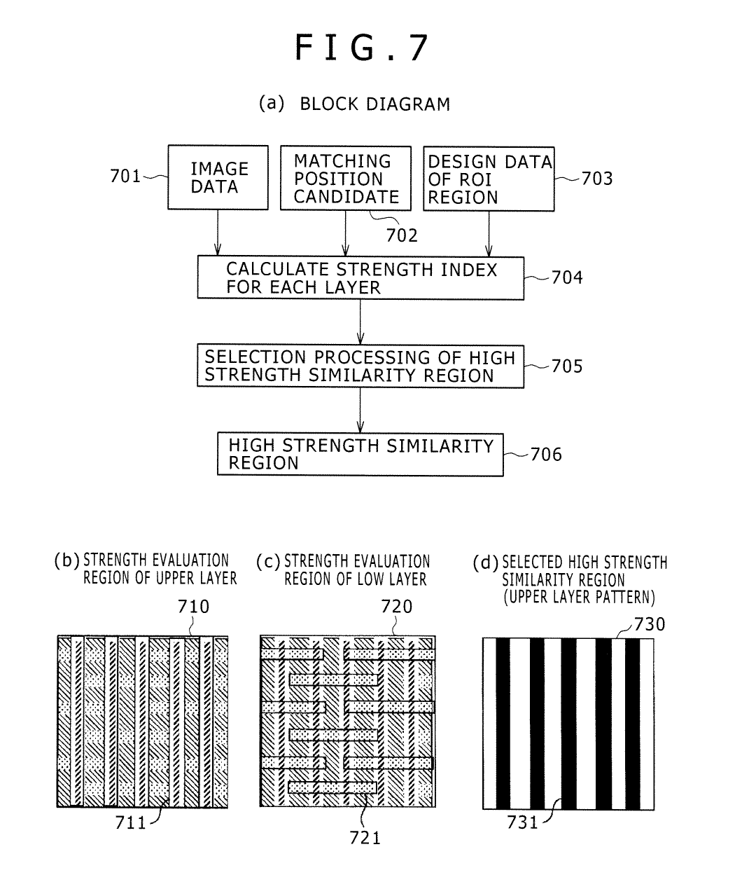

The former will be described with reference to FIG. 7 later. The latter is a method in which information on the region which is the high similarity region obtained in advance is accepted as an input of the user, or the high similarity region is fixedly set within the matching processing. In this case, a selection processing unit 403 of the high strength similarity conducts the processing for selecting the design data of the appropriate layer with the high strength from design data 402 of the ROI region on the basis of information 401 on the design data which is the high strength, and outputs a high strength similarity region 404. When the information 401 on the layer of the design data which is the high strength is accepted as the input of the user as described above, for example, an image (or an image from which an image to be observed similar in shape and composition thereto can analogize) obtained by observing the specimen by the inspection device is provided as an image for specifying the layer of the region having the high strength by the user, and the layer of the high strength similarity region determined by the user on the basis of the provided image is accepted as an input.

In this example, the provision of the image is not always necessary, and only the layer of the high strength similarity region is accepted as the input of the user (in this case, for example, the user makes a determination on the basis of the past experience or the results of simulation, and specifies the high strength similarity region). Also, when the high similarity region is fixedly set, since a larger number of discharge electrons is frequently detected in the upper layer pattern in, for example, an electronic microscope image of a semiconductor pattern, it is conceivable that the upper layer pattern is set as the layer that is the high strength. The upper layer pattern does not always become the high strength depending on the type of a specimen (the type of material or structure), or observation conditions of the device (if the electronic microscope is provided, an accelerating voltage, a probe current, the type of an electron detector (location position or detection conditions), a state of the other device magnetic field, etc.). The region that becomes the high strength may be different depending on the type of specimen or the conditions of the device. In this case, the region that becomes the high strength is set under those conditions.

In the region that becomes the high strength, for example, the inspection device calculates the acquired image through simulation based on the type of specimen and the observation conditions of the device, and may select the region which becomes the high strength from the calculated image. This processing is conducted by the designation processing unit 106 of the high strength region in FIG. 1. As a result, the region of the high strength that is removed by the removal processing unit 107 of the high strength similarity region can be designated in the image 100 of the inspection device that fails matching because the regions of the high strength and the low strength of the edge strength are mixed together.

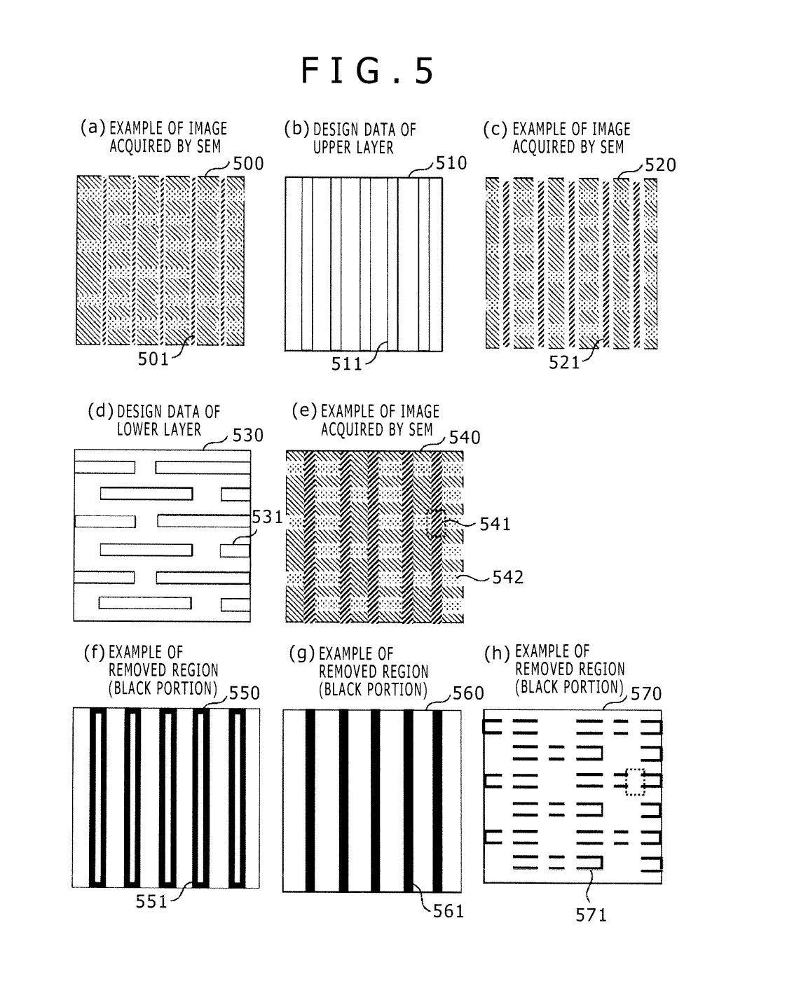

FIG. 5 is a diagram illustrating a second method for removing the high strength similarity region from the image data 100 in the removal processing unit 107 of the high similarity region in FIG. 1. The method for removing the high similarity region described above with reference to FIG. 3 is the method for removing all of the regions in which the pattern of the designated layer is present in the design data. In this example, a description will be given of a method in which a region of the high strength is further designated (or extracted) in the designated layer on the basis of the design data, and the designated (or extracted) region is removed from the image data 100 acquired by the inspection device. As a result, the similarity region of the hi strength removed from the image 100 can come closer to the similarity region of the high strength in an actual image, and the region of the low strength in the designated layer can be prevented from being deleted more than necessary.

For example, as illustrated in FIG. 5A, a semiconductor pattern 500 actually formed may be separated in shape from a pattern 510 described in the design data (an example in which an actual semiconductor pattern 501 is different in a line width of a line pattern from a pattern 511 of the design data). However, even if this separation is present, only the high strength similarity region can be removed as much as possible. Alternatively, for example, in the SEM, a larger number of electrons are discharged from the edge portions and side wall portions than those from other plan portions of the specimen. Therefore, as illustrated in FIG. 5C, the pattern edge portions in the SE image is different from the design data in that there are wide regions 521 (also called “white bands”) having a high gradation value. Only the white bands are removed as regions of the high strength. Alternatively, as illustrated in FIG. 5E, a layer designated as the high strength similarity region (in this example, a lower layer pattern 531 in FIG. 5D forms the high strength similarity region), when a pattern 541 of the low strength in the actual image overlaps with or is included in a region where the pattern is present in the design data of the layer of the high strength similarity region (for example, the pattern of the layer other than the layer of the high strength similarity region overlaps as in the region indicated by a dashed line of FIG. 5E), the region in which the pattern of the low strength is present can be prevented from being removed more than necessary. Subsequently, a description will be given of specific implementation methods of the above-mentioned three cases.

In an SEM image 500 illustrated in FIG. 5A, it is assumed that the design data 510 of the upper layer, for example, illustrated in FIG. 5B is designated as the layer of the high strength similarity region. In this example, the line width of the line pattern in the SEM image 500 is different from the design data (in this example, the line width is thin, but may be thick). Under the circumstances, as illustrated in FIG. 5G, the line width of the line pattern in question is changed (in this example, the line width is thin, but not limited to be thin, and the same is applied to a thick line). As the changing method, for example, the number pix for designating a line width size is changed (for example, the expansion or reduction processing of the region is conducted by the image processing). As the designation of the change size, there is a method in which the amount of change is accepted from the user, or a method in which the change size is set on the basis of the simulation results of the semiconductor process. The method of setting the amount of change is not limited to this method, but any method is applicable if the same amount of change as that of the image acquired by the actual inspection device can be set.

Also, in an SEM image 520 illustrated in FIG. 5C, it is assumed that the design data 510 of the upper layer, for example, illustrated in FIG. 5B is designated as the layer of the high strength similarity region. In the design data 510 of the layer designated as the high strength similarity region, a peripheral region of the edge region 511 of the pattern is designated to the high strength similarity region. FIG. 5F illustrates an example of the designated region 551. For example, as a region corresponding to the thickness of the white band, the region of the width of the number pix along the edge portion of the pattern is designated. Regions other than the designated region are not removed. As a result, only the portion of the white band of the high strength region can be removed.

Also, in an SEM image 540 illustrated in FIG. 5E, it is assumed that design data 530 of the lower layer, for example, in FIG. 5D is designated as the layer of the high strength similarity region. The region designated as the high strength similarity region is the lower layer pattern, and in the SEM image 540, the pattern 541 of the upper layer overlaps with the lower layer pattern so that the lower layer pattern is hidden from view (for example, a region surrounded by a dashed line of FIG. 5E).

Under the circumstances, as illustrated in FIG. 5H, processing for removing the region of the lower layer pattern with which the upper layer pattern overlaps in the design data from the region removed as the high strength similarity region is conducted (for example, a region surrounded by a dashed line of FIG. 5H). For example, the region to be removed is the upper layer pattern and the lower layer pattern in the design data, and the region in which both of those patterns are present can be calculated by logical operation. A method of calculating the region to be removed is not limited to this method, but any method of extracting a portion where the high strength similarity region overlaps with the other region is applicable.

In addition, the formed semiconductor pattern may be separated from the shape of the design data due to a variety of factors (Patent Literature 4). Under the circumstances, a pattern brought closer to a shape of the semiconductor pattern by treating the design data may be used instead of the design data described above. As an example, there is a method in which the design data is subjected to Gaussian filter processing, and the processing results are subjected to contour extraction to obtain the shape brought closer to the actual pattern shape. Also, there is a method in which the design data is subjected to exposure simulation, and the simulation results are subjected to contour extraction to obtain a shape brought closer to the actual pattern shape (Patent Literature 4).

The methods of creating the region to be removed as the high strength similarity region have been described above. However, the respective methods may be used, independently, or the respective methods may be used in combination. In this way, the removal region is set according to the status of the similarity region of the high strength in the image of the inspection device, thereby being capable of improving the performance of selection of the correct position in the matching method described with reference to FIG. 1.

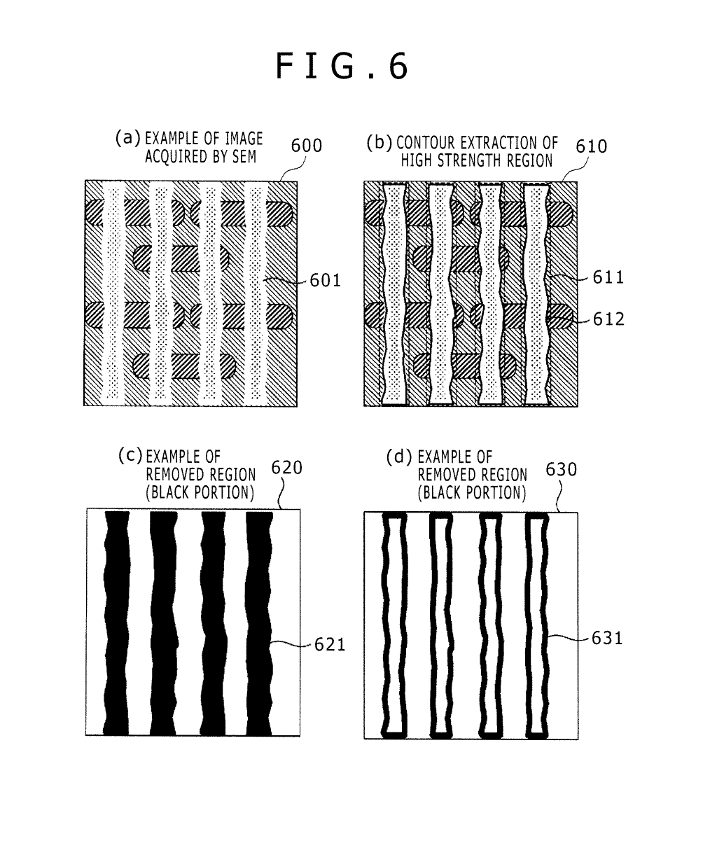

FIG. 6 is a diagram illustrating a third method for removing the high strength similarity region from the image data 100 in the removal processing unit 107 of the high similarity region in FIG. 1. The method for removing the high strength region described with reference to FIG. 3 or 5 is the method in which all of the regions in which the pattern of the layer designated in the design data is present are set as the regions to be removed, or the method in which the regions to be subjected to the specific processing on the basis of the design data are set as the regions to be removed.

In this example, a method will be described in which the region of the high strength is designated (or extracted) on the basis of both of the design data of the designated layer, and the image acquired by the inspection device, and the designated (or extracted) region is removed from the image data 100 acquired by the inspection device. As a result, the high strength similarity region removed from the image data 100 can be brought closer to the similarity region of the high strength in the actual image. Also, the removal of the high strength similarity region makes it possible to prevent the region of the low strength from be removed more than necessary.

An example of a specific implementation method will be described. FIG. 6A illustrates an image acquired in the inspection device, and an upper layer pattern 601 is the similarity region of the high strength. In order to extract this region, the region is subjected to the contour extraction processing (for example, Nonpatent Literature 1, pp. 253, pp. 1651) by the image processing. FIG. 6B illustrates an example of the results of extracting a contour 612. This extracts the contour 612 with an upper layer pattern 611 of the design data as an initial condition. In the region to be removed as the similarity region of the high strength, there is a method in which the design data 311 of the layer to be removed in the method described in FIG. 3 is replaced with the extracted contour line. That is, as illustrated in FIG. 6C, all of the regions inside the contours are set as regions 621 to be removed. Alternatively, there is a method in which the design data (510 or 531) of the layer to be removed in the method described with reference to FIG. 5 is replaced with the extracted contour lines. That is, as illustrated in FIG. 6D, for example, the regions having only a certain width changed whose contour has been designated are set as the regions to be removed. All of the methods described with reference to FIG. 5 can be applied without limited to a change in the width. As a result, in the matching method described with reference to FIG. 1, the performance of selection of the correct position can be improved.

FIG. 7 is a block diagram illustrating a configuration of a second method for designating the high strength similarity region to be removed from the image data 100 in the designation processing unit 106 of the high strength similarity region described with reference to FIG. 1, and a diagram illustrating the method. The method described above with reference to FIG. 3 is the method of acquiring the information on the high strength region from the image acquired in the inspection device or the property of the observation specimen before the image is acquired. In this example, a method will be described in which the high strength similarity region is extracted from the image picked up by the inspection device through the image processing.

In this method, there is no need to acquire and set the information before imaging the specimen as in the method described with reference to FIG. 3, and the similarity region of the high strength can be designated even when prior information cannot be acquired, or the high strength similarity region different from that of the prior information is produced. Also, a work for collecting the prior information, or the user setting work can be saved. This method is a method of setting the region for evaluating the strength for each layer of the design data, and setting the highest strength region as the region to be removed in each of the evaluation regions.

A specific implementation method will be described. FIG. 7A is a block diagram of a configuration in this method. The strength evaluation region based on each layer of the design data is set for a region of image data 701 corresponding to a position of each matching position candidate 702 which will be described later, an index value for evaluating the strength for each layer is calculated 704, a layer that becomes the high strength is selected from the calculation results 705, and the selected region is set as a similarity region 706 of the high strength.

Examples of the strength evaluation region based on the design data are illustrated in FIGS. 7B and 7C. This example shows a semiconductor pattern of a double-layered structure. FIG. 7B illustrates an example in which an evaluation region 711 of the upper layer pattern is set in the image acquired by the inspection device, and FIG. 7C illustrates an example in which an evaluation region 721 of the lower layer pattern is set in the image acquired by the inspection device. An evaluation index value of the strength is calculated in each of the evaluation region 711 of the upper layer pattern, and the evaluation region 721 of the lower layer pattern. As the index value, for example, a mean value of the edge strength or a mean pixel value within the evaluation region, or a correlation value between the image acquired by the device and the template is used. The index value having the higher strength is selected as the high strength similarity region 730.

The evaluation index is not limited to the above indexes, but any index value that enables a comparison of the strengths can be applied. Also, this example shows the pattern of the double-layered structure. Similarly, in a pattern of three or more layers, the evaluation region is set in each of the layers to calculate the evaluation index value in each of the layers, and the high strength similarity region can be selected from the evaluation index values.

With the above configuration, the high strength similarity region can be extracted from the images picked up by the inspection device through the image processing.

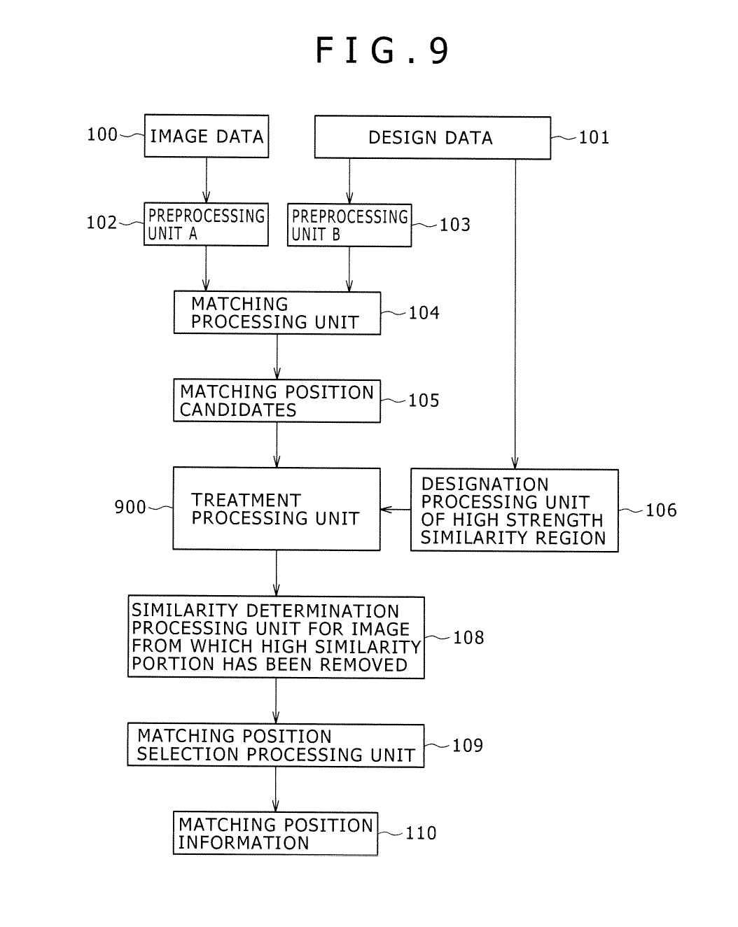

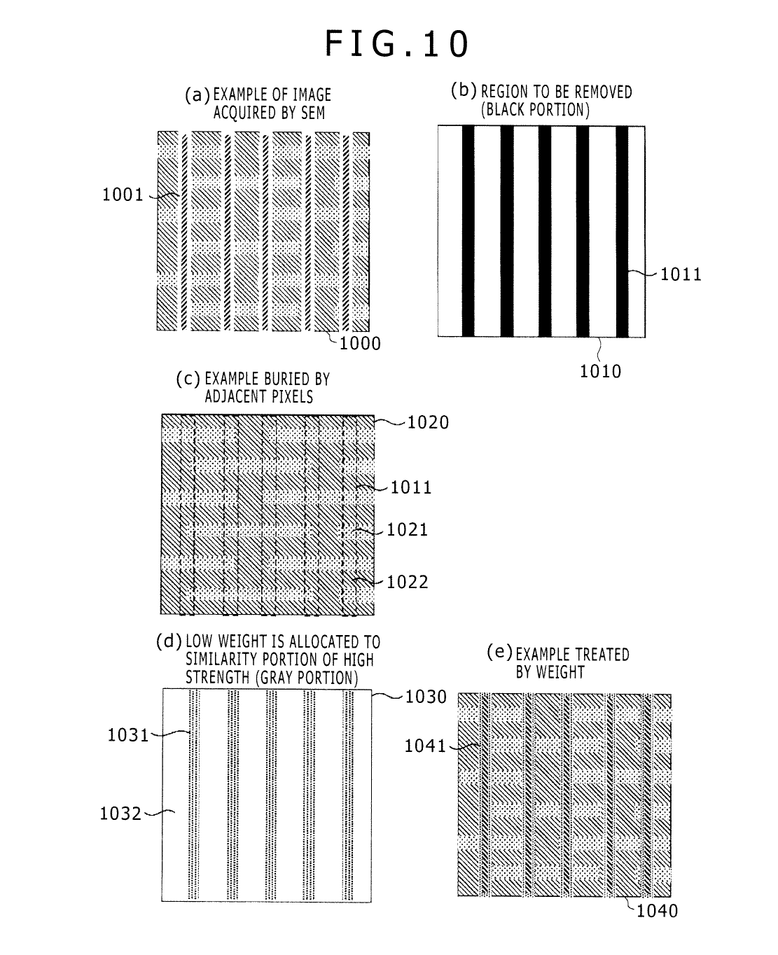

FIG. 9 is a block diagram illustrating a configuration of the template matching processing according to another embodiment. A difference from the embodiment described with reference to FIG. 1 resides in that a treatment processing 900 of the high strength similarity region is conducted. In FIG. 1, there is applied the method of removing the high strength similarity region from the image acquired by the inspection device through the removal processing unit 107. The removed region in this example may include information on the pattern of a layer other than the layer intended to be removed. This is, for example, a case in which the layer laid under the removed layer appears to transparently overlap with the removed layer, or a case in which the pattern is present on the removed layer. When the information on the layer other than the layer of the high strength similarity region is also removed, there is a risk that the matching correct position cannot be selected by the matching method described with reference to FIG. 1 because of the lost information. Under the circumstances, in this example, the region of the high strength removed in FIG. 1 is not removed, but the region in question is treated, and information on the pattern of the other layers remains while reducing the information on the high strength (a specific example will be described with reference to FIG. 10). With the above configuration, in the method of FIG. 1, since a part or all of the information removed from the image data 100 acquired by the inspection device remains, the selection performance of the matching correct position can be improved in the similarity determination processing unit 108 and the matching position selection processing unit 109.

Hereinafter, this method will be described with reference to FIG. (this method is identical with the method of FIG. 1 except for a treatment processing unit 900 of the high strength similarity region). An input is the image data 100 acquired by the inspection device, and the design data of the ROI region. In the preprocessing A102, processing for reducing an influence of noise included in the image on the matching processing is conducted. For example, as processing, noise reduction processing such as the Gaussian filter processing or the median filter processing (Nonpatent Literature 1, pp.1670) is conducted. The noise reduction processing is not limited to those processing, but any processing that can reduce the noise can be applied. Further, edge emphasis processing is conducted to emphasize the shape of the pattern. For example, the Sobel filter processing (Nonpatent Literature 1, pp. 1215) is conducted. The edge emphasis processing is not also limited to this configuration, but any processing that can conduct the edge emphasis can be applied.

Both of the noise reduction processing and the edge emphasis processing in the preprocessing of this preprocessing unit A are not always implemented, but any one or both of those processing may not be implemented. In the preprocessing unit B103, the edge emphasis processing is conducted to emphasize the shape of the pattern of the design data. For example, the Sobel filter processing (Nonpatent Literature 1, pp. 1215) is conducted. The edge emphasis processing is not also limited to this configuration, but any processing that can conduct the edge emphasis can be applied.

Also, the above processing of the preprocessing unit B is not always implemented, but the processing may not be implemented. In the matching processing unit 104, the template matching is conducted (Nonpatent Literature 1, pp. 1670). For example, the matching processing using the normalized correlation method (Nonpatent Literature 1, pp. 1672) is conducted. The position of the region of the pattern similar between the template and the image to be searched can be detected through the matching processing. The designation processing unit 106 selects a plurality of matching positions higher in the degree of similarity (for example, correlation value). The selected matching positions are the matching position candidates 105, and as described above, the matching position candidates include the matching correct positions and the matching incorrect positions in most situations.

The designation processing unit 106 of the high strength similarity region designates the region in which the above-mentioned edge strength is high. The high strength similarity region represents a region in which the degree of similarity between the template and the image to be searched is high, and the strength is high, a region in which the degree of similarity is high, and the strength is expected to be high, or a region including those regions (region including those regions in this case represents, for example, a region of a layer in which there is the design data including the region high in the similarity and high in the strength).

A treatment processing unit 900 of the high strength similarity region treats the regions of the image data (image to be searched) corresponding to the respective matching position candidates, in the region designated by the designation processing unit 106 of the high strength similarity region described above. A specific example of the treatment method will be described with reference to FIG. 10. The image data in this example may be an image preprocessed in the preprocessing A102, or the image data 100 acquired by the inspection device as it

In the similarity determination processing unit 108 for the image in which the high strength similarity region is treated, the degree of similarity is evaluated for the image data obtained by the removal processing unit 107 of the high strength similarity region described above with the use of the pattern of the template other than the removed region. This makes it possible to evaluate the degree of similarity in which the similarity region of the high strength is treated in the respective matching position candidates, and mainly makes it possible to evaluate the degree of similarity in the pattern of the low strength.

In the matching position selection processing unit 109, the degrees of similarity at the respective matching candidate positions obtained by the above similarity determination processing unit 108 for the image in which the high strength similarity region has been deleted are compared with each other, and the candidates highest in the degree of similarity are output as the matching position 110. With the above processing, even if the high strength and the low strength of the edge strength are mixed together in the pattern to be searched on the image to be searched, it is possible to determine an accurate matching position by the template matching.

FIG. 10 is a diagram illustrating a method for treating the high strength similarity region in the treatment processing unit 900 of the high strength similarity region described in FIG. 9. FIG. 10A illustrates an example of image data 1000 acquired in the inspection device. A specimen of this multilayered structure is of a double-layered structure, and an upper layer pattern 1001 is a region of the high strength. Hence, the high strength similarity region to be processed is an upper layer pattern 1011 in the design data illustrated in FIG. 10B.

FIG. 10C is a diagram illustrating an example of the treatment results. In this treatment, the treatment region 1011 is subjected to interpolation processing by the pixel values in the region around the treatment region to fill the pixel values of the treatment region (in this example, the pixel value of the treatment region is interpolated by the pixel values adjacent to the right and left side of the treatment region). An interpolation method of the image data is described in, for example, Nonpatent Literature pp. 1360. With this method, the information on the adjacent patterns other than the pattern of the high strength region which is in the high strength region is assumed, and the high strength region can be filled (interpolated) with that information. In this way, an original image is subjected to processing for relatively reducing the information of the high strength region (the upper layer pattern in this example) , to thereby make it possible to conduct the similarity determination with the use of the image in which the information of the high strength region is reduced.

Also, FIGS. 10D and 10E are diagrams illustrating another treatment method different from the interpolating method using the adjacent pixels described above. In this method, the treatment region (the high strength similarity region) is weighted to reduce the strength (that is, the information (signal) of the high strength region is reduced). FIG. 10D illustrates an example of the weighting. For example, a weight of a treatment region 1031 is reduced more than the weight of a region 1032 other than the treatment region. As a result, for example, as illustrated in FIG. 10E, the strength of 1041 which is the high strength similarity region can be weakened. The weight in this example is not limited to a uniform value, but can be multivalued.

Also, in the template provided for determination of the degree of similarity, the amount of signals in a region corresponding to the above treatment region is reduced, thereby making it possible to enhance the degree of similarity at the matching correct position on the image that has been subjected to the above image processing.

In this example, the method of treating the high strength similarity region for the pattern of the double-layered structure has been described. However, this is not limited to the double layer, but the same processing can be conducted on the three or more patterns. The high strength similarity region can be treated by the above-mentioned method.

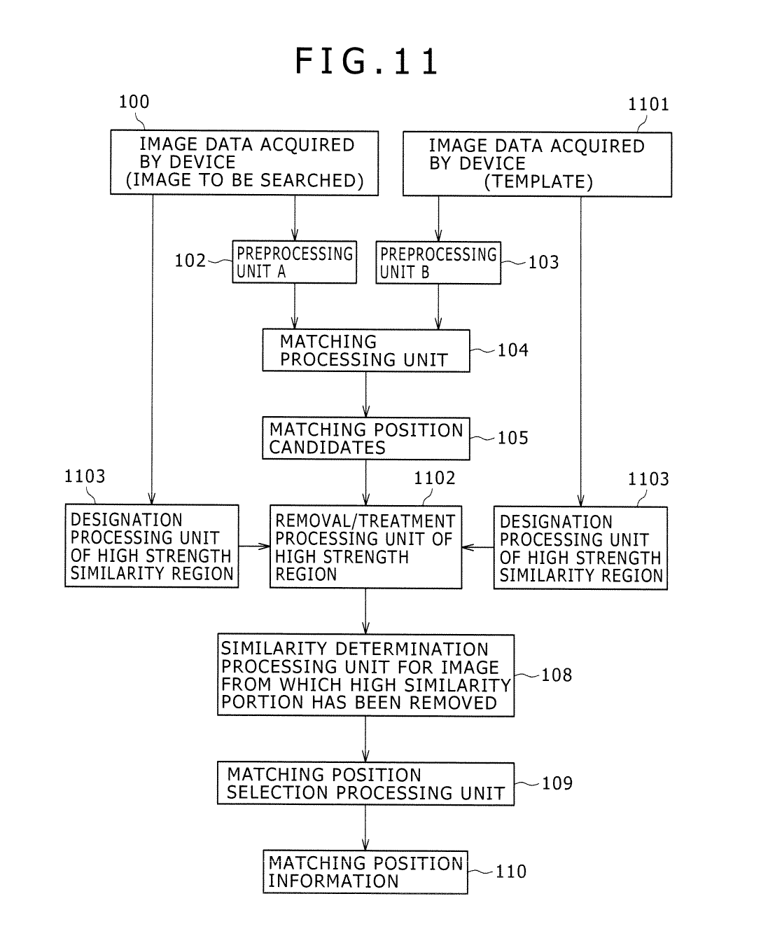

FIG. 11 is a block diagram illustrating a configuration of the template matching processing according to still another embodiment. A different from the first or second embodiment described in FIGS. 1 and 9 resides in that the template is not the design data but the image 1001 acquired by the inspection device. According to this method, even when the design data is not prepared in advance before the inspection, the similarity evaluation is conducted with the removed or treated the similarity region of the high strength, and the selection performance of the matching correct position can be improved. This method is different from the methods of FIGS. 1 and 9 in that the design data is not used in a designation processing unit 1103 of the high strength similarity region, and the removal/treatment of the high strength region is conducted on both of the image to be searched, and the template . A method of designating the high strength similarity region by the designation processing unit 1103 of the high strength similarity region will be described with reference FIG.

Hereinafter, this method will be described with reference to FIG. 11. Input is template image data 1101 acquired by the inspection device as the template, and image data to be searched 100 acquired by the inspection device. In the preprocessing A102 and the preprocessing unit B103, processing for reducing an influence of the noise included in the image on the matching processing is conducted. For example, as the processing, the noise reduction processing such as the Gaussian filter processing or the median filter processing (Nonpatent Literature 1, pp.1670) is conducted. The noise reduction processing is not limited to those processing, but any processing that can reduce the noise can be applied. Further, edge emphasis processing is conducted to emphasize the shape of the pattern.

For example, the Sobel filter processing (Nonpatent Literature 1, pp. 1215) is conducted. The edge emphasis processing is not also limited to this configuration, but any processing that can conduct the edge emphasis can be applied. Both of the noise reduction processing and the edge emphasis processing in the preprocessing of this preprocessing units A and B are not always implemented, but any one or both of those processing may not be implemented. In the matching processing unit 104, the template matching is conducted (Nonpatent Literature 1, pp. 1670).

For example, the matching processing using the normalized correlation method (Nonpatent Literature 1, pp. 1672) is conducted. The position of the region of the pattern similar between the template and the image to be searched can be detected through the matching processing. The designation processing unit 106 selects a plurality of matching positions higher in the degree of similarity (for example, correlation value). The selected matching positions are the matching position candidates 105, and as described above, the matching position candidates include the matching correct positions and the matching incorrect positions in most situations. The designation processing unit 1103 of the high strength similarity region designates the regions in which the edge strength is high as described above.

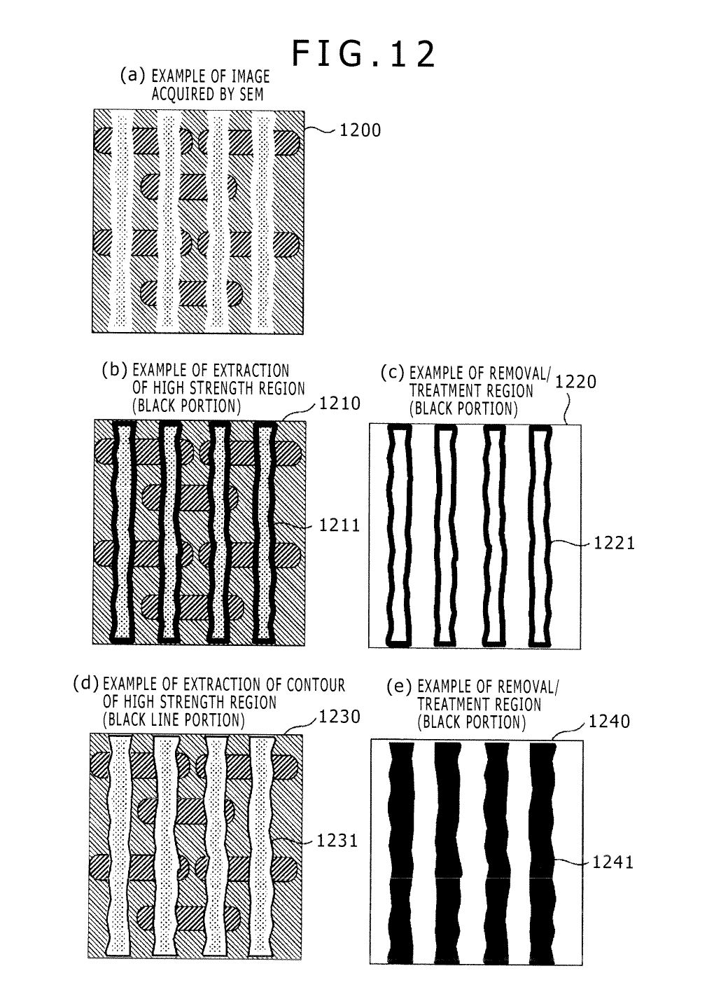

A removal/treatment processing unit 1102 of the high strength similarity region removes/treats the regions of the image data (image to be searched, and the template image) corresponding to the respective matching position candidates, in the region designated by the designation processing unit 106 of the high strength similarity region described above. A specific example of the removal/treatment method will be described later with reference to FIG. 12. The image data in this example may be an image preprocessed in the preprocessing units A102 and B, or the image data 100, and 1101 acquired by the inspection device as they are.

In the similarity determination processing unit 108 for the image in which the high strength similarity region is removed/treated, the degree of similarity is evaluated for the image data to be searched obtained by the removal processing unit 107 of the high strength similarity region described above with the use of the template obtained by the removal processing unit 107 of the high strength similarity region. This makes it possible to evaluate the degree of similarity in which the similarity region of the high strength is removed/treated in the respective matching position candidates, and mainly makes it possible to evaluate the degree of similarity in the pattern of the low strength.

In the matching position selection processing unit 109, the degrees of similarity at the respective matching candidate positions obtained by the above similarity determination processing unit 108 for the image in which the high strength similarity region has been deleted are compared with each other, and the candidates highest in the degree of similarity are output as the matching position 110. With the above processing, even if the high strength and the low strength of the edge strength are mixed together in the pattern to be searched on the image to be searched and in the pattern to be searched on the template, it is possible to determine an accurate matching position by the template matching.

FIG. 12 is a diagram illustrating a method for designating the high strength similarity region, and a method for treating/removing the high strength similarity region, in the designation processing unit 1103 of the high strength similarity region and the removal/treatment processing unit 1102 of the high strength region, which are described with reference to FIG. 11. Unlike a case of the method of FIG. 1 or 9, the designation of the high strength similarity region extracts and designates the high strength similarity region from an image 1200 acquired by the inspection device without the use of the design data.

In this example, the region of the high strength is, for example, the regions in which the edge strength is high, or the pixel value is high. For example, as the former regions in which the edge strength is high, proper binarization processing (Nonpatent Literature 1) is conducted on the edge image of the image 1200, and the regions corresponding to a side in which the value is higher may be extracted. Also, as the latter regions in which the pixel value is high, the binarization processing is conducted on the image 1200, and the regions corresponding to a side on which the value is higher may be extracted. The method of extracting the regions in which the edge is high in strength, or the pixel value is high is not limited to the binarization processing, but any methods that can extract the appropriate regions can be applied.

In this method, an example of the extracted high strength region is a region 1211 indicated in an image 1210 of FIG. 12B. As illustrated in FIG. 12C, the region 1211 as it is can be designated to a region 1221 to be removed or treated. Also, like the configuration described with reference to FIG. 6, a contour line of the region 1211 is extracted, and all 1241 inside of a region indicated by the contour line, or a region obtained by widening the contour line by a given designated width can be designated to the region to be treated/removed. Also, when the high similarity region is treated, as described with reference to FIG. 10, the interpolation processing or the weight processing may be conducted. As a result, the high strength similarity region can be designated, and the high strength region can be treated/removed by the designation processing unit 1103 of the high strength similarity region, and the removal/treatment processing unit 1102 of the high strength region which are described with reference to FIG. 11.

FIG. 13 is a diagram illustrating an example of the GUI that enables a setting method of the removal/treatment region when the high strength similarity region is subjected to the removal/treatment processing, and the setting of the removal method to be accepted from the user. This figure illustrates an example of a GUI 1300 displayed on the display device 820 of the inspection device in which the removal/treatment processing of the high strength similarity region is conducted on the matching candidates obtained by the matching processing, and the matching correct position can be selected by the similarity determination processing. It can be selected by a check box 1301 whether the selection of the matching correct position by the removal/treatment processing of the high strength similarity region and the similarity determination processing which are described in the present specification is executed, or not . If the execution is selected, the matching between the measurement data and the device image, or the matching between the device image and the device image can be selected by a select box 1302 or 1312.

When the matching between the measurement data and the device image is selected, the setting of the setting method of the removal/treatment region, and the removal method can be accepted from the user. In the setting of the removal/treatment region, if a select box 1303 is selected, an input box 1319 can accept the input of the layer in the design data to be subjected to removal/treatment (the method described with reference to FIG. 4). Also, when the select box 1304 is selected, the layer of the design data to be subjected to removal/treatment can be automatically selected (the method described with reference to FIG. 7). Also, the setting of the correction of the removal/treatment region can be accepted from the user, and when a check box 1306 is selected, the region in which the removal/treatment is manually conducted can be designated or edited.

The designation and the edition can be conducted while confirming the region in a display region 1323 of the high strength similarity region. Also, when a check box 1325 is selected, the extracted region can be expanded or reduced by a value (for example, set in a pix unit) input to the input box 1321. Also, when the @1307 is selected, the region setting by the contour extraction processing can be conducted (the method described in FIG. 6). Also, the setting of the details of the removal/treatment region can be accepted from the user, and if a select box 1308 is selected, a method of setting the overall region as the removal/treatment region can be selected (the method described in FIG. 3), and if a select box 1326 is selected, a method of setting an edge periphery of the region as the region to be removed/treated can be selected (the method described in FIG. 5).

In the latter case, an input of a width (for example, set in a pix unit) of the region can be accepted by an input box 1322. In select boxes of the removal method, the removal or treatment method can be selected. If a select box 1309 is selected, the removal of the high strength region can be selected (the method described with reference to FIG. 3). Also, when a select box 1310 is selected, the high strength region can be interposed by the adjacent pixels (the method described with reference to FIG. 10). Also, when a select box 1311 is selected, the high strength region can be subjected to weight processing (the method described with reference to FIG. 10).

Even when the matching between the measurement data and the device image is selected, the setting of the setting method of the removal/treatment region, and the removal method can be accepted from the user. In the setting method of the removal/treatment region, if a select box 1313 is selected, the layer of the high strength can be automatically selected (the method described with reference to FIG. 12). Also, when a select box 1314 is selected, the region can be manually designated and treated. The designation and the treatment can be conducted while confirming the region in the display region 1323 of the high strength similarity region. Also, in select boxes of the removal method, the removal or treatment method can be selected. If a select box 1315 is selected, the high strength region can be removed (in this method, the method described with reference to FIG. 3). Also, if a select box 1316 is selected, the high strength region can be interpolated by the adjacent pixels (the method described in FIG. 10) Also, if a select box 1317 is selected, the high strength region can be subjected to the weight processing (the method described with reference to FIG. 10).

With the above processing, the setting of the setting method of the removal/treatment region when the removal/treatment processing of the high strength similarity region is conducted by the GUI, and the removal method can be accepted from the user. This GUI does not need to provide all of the members described above, but provides all or a part of the members.

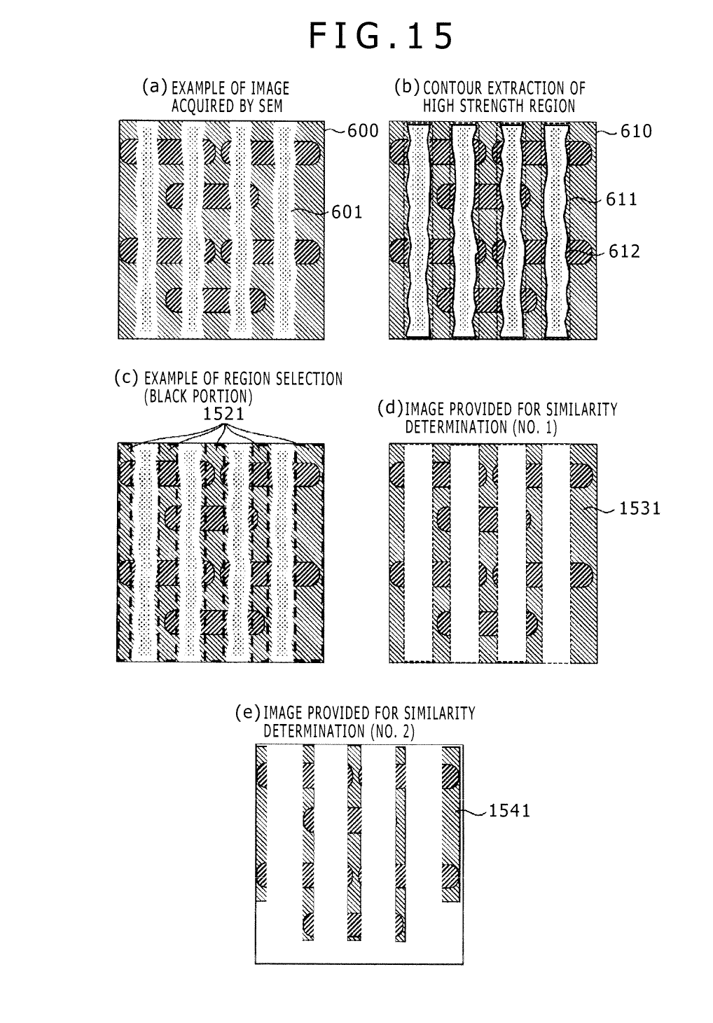

In the above description, mainly, the high strength region of the signal is removed, or the brightness thereof is weakened to specify a desired matching position from the matching position candidates. Alternatively, the high strength region is not selectively removed, but the low strength region may be selected, resulting in the removal of the high strength region. FIG. 15 is a diagram illustrating an example of selecting a region low in contrast such as the lower layer pattern as an image for determination of the degree of similarity. FIGS. 15A and 15B are identical with FIGS. 6A and 6B. In this example, the removal region is not set, but a select region 1521 is selected, and an image 1531 for determination of the degree of similarity is formed on the basis of this selection. Even in this technique, the precise matching position can be specified while suppressing an influence of the high strength region.

Also, FIG. 15E is a diagram illustrating an example of selectively extracting particularly the region in which the pattern is present among the low strength regions. All of the selected regions are not used for determination of the degree of similarity, but even if the image is formed on the basis of the regions in which the pattern is present, the matching position can be precisely specified.

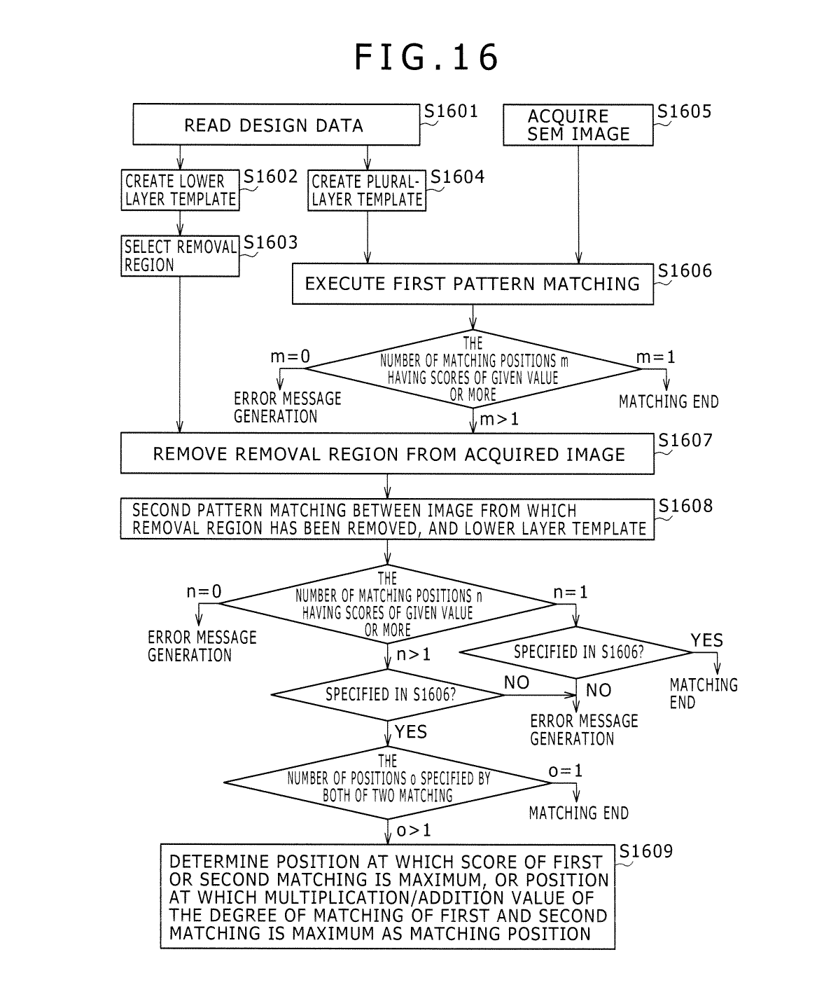

FIG. 16 is a flowchart illustrating a process of determining the matching position on the basis of plural times of pattern matching processing. A difference from the pattern matching method described in FIG. 1 resides in that second pattern matching is conducted with the use of the lower layer template after the removal region has been removed from the image.

First, information necessary for template creation is read from a storage medium (the design data storage medium 1417, or the memory 1408) on the basis of the setting of an arbitrary region on the design data (Step 1601). The creation of multilayered templates provided for the first pattern matching (Step 1604), and the creation of the lower layer template provided for the second template matching (Step 1602) are conducted. Further, the removal regions of the image when conducting the second pattern matching are selected (Step 1603).

Subsequently, the image to be subjected to the pattern matching is acquired (Step 1605), and the pattern matching using multilayered template created in Step 1604 is executed (Step 1606). In this situation, if the number m of matching positions which exceed a threshold value (given value) of a preset matching score is zero, an error message is generated together with the processing of skipping the measurement based on the matching in question assuming that a target could not been found out. Also, if the number m of matching positions is 1, the matching processing is terminated assuming that the number of correct positions is 1, that is, a final matching position cannot be specified. It is conceivable that the number of matching positions is only one because the specimen is charged, and the resolution of the image is low. In this case, it is preferable that the error message is generated. The dealing may be changed according to status of the specimen and the measurement environments.

In this example, if the number of matching positions is larger than 1, that is, if a plurality of matching positions can be specified, the flow proceeds to the next step. A threshold value is also set for the number of matching positions, and m higher matching positions higher in the score may be specified.

Subsequently, the removal regions selected in Step 1603 are removed from the SEM image acquired in Step 1605 to create the removal image (Step 1607). The removal region is, for example, a region set to cover the contour of the upper layer pattern, and a region slightly larger than the contour of the upper layer pattern may be set as the removal region. The pattern matching using the lower layer template created in Step 1602 is executed on the removal image thus formed (Step 1608). That is, in a flowchart exemplified in FIG. 16, the image from which the information of the upper layer pattern has been removed, and the lower layer pattern are selectively extracted, and the matching determination based on the pattern matching between the extracted one and the lower layer template in which the upper layer pattern is not present is executed.

If the number n of matching positions in Step 1608 is 0, because an appropriate lower layer pattern could not been detected, the error message is generated. Also, if n is 1, the matching processing is terminated assuming that the matching is properly conducted under the condition where the matching position in question is specified even in the pattern matching in Step 1606. Also, if the matching position in Step 1608 does not match the matching position in Step 1608, the error message is generated under the determination that the matching has not been properly conducted.

If the number n of matching positions in Step 1608 is plural (n>1), the number o of matching positions specified by both of Step 1606 and Step 1608 is determined. If o is 1, the matching processing is terminated assuming that the number of proper matching positions is 1. If o is plural (o>1), because a plurality of matching position candidates is present, a position at which the matching score in Step 1606 or Step 1608 is maximum, or a position at which a multiplication value of the degree of matching of both the matching, or an addition value of the matching scores becomes maximum is determined as the matching position (Step 1609).

If a plurality of matching processing is conducted with the use of the different templates as described above, a possibility that positioning is conducted at an incorrect position can be reduced.

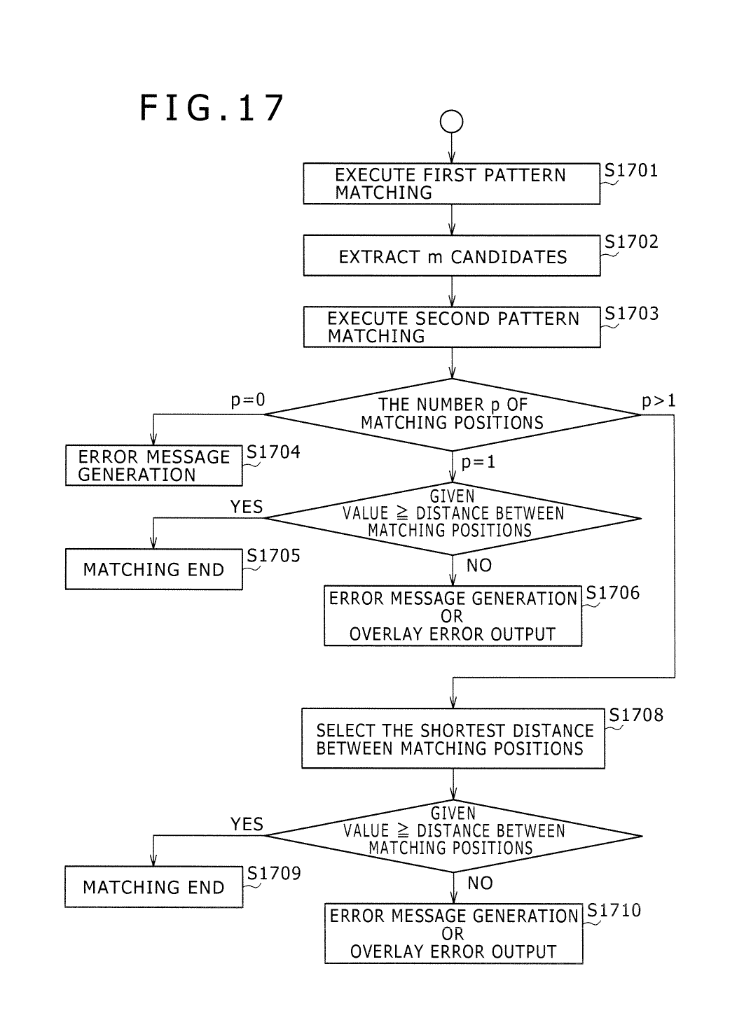

Like FIG. 16, FIG. 17 is a flowchart illustrating a process of determining the matching position on the basis of plural times of pattern matching processing. In particular, in the processing exemplified in FIG. 17, even if an overlay error is present between the upper layer pattern and the lower layer pattern, attention is focused on the proper execution of the pattern matching. Steps 1701 to 1703 are substantially identical in the processing with Steps 1601 to 1608. If the number p of matching positions specified by both of those two matching is zero, an error message is generated assuming that the matching is not property conducted (Step 1704). Also, in the case where the number p of matching positions specified by the two matching is 1, if both of those matching position are a given threshold value or lower, the matching is terminated assuming that the matching is successful (Step 1705). If a distance between the matching positions exceeds a given threshold value, an output for displaying a matching failure or an overlay error on a display device is conducted assuming that the matching failure or a deviation (overlay error) between the layers is generated (Step 1706).

As has been described above, taking the deviation between the two matching positions into consideration, the deviation of some degree is determined as the generation of the overlay error. If the deviation is larger, the possibility of the matching at the incorrect position is suppressed by generating an error, and a success rate of the matching can be enhanced without depending on the overlay error. Also, the overlay error can be measured on the basis of the distance between the positions specified by the two matching. In this embodiment, in particular, the position specified by the first pattern matching is a position specified as a result of being more affected by the upper layer pattern, and the position specified by the second pattern matching is a position corresponding to the position of the lower layer pattern. Hence, the deviation (the amount of shift) between those positions can be defined as an overlay error.

Further, if the number p of matching positions is larger than 1 (p>1), the shortest distance between the two matching positions is selected, or a distance between the two matching positions which fulfills a given conduction (for example, a the threshold value or lower) is selected (Step 1708). Then, the same processing as that in Steps 1705 and 1706 is executed.

### LIST OF REFERENCE SIGNS

801, electron gun
802, stage
803, semiconductor wafer
804, beam deflector
805, objective lens
806, secondary electron detector
807, 809, 810, 812, A/D converter
808, reflection electron detector
811, optical camera

1. A pattern matching device including an image processing unit that executes pattern matching on an image with the use of a template formed on the basis of design data or a picked-up image,
wherein the image processing unit executes the pattern matching on a first target image with the use of a first template including a plurality of different patterns, creates a second target image with the exclusion of information on a region including a specific pattern among a plurality of patterns from the first target image, or with the reduction of the information on the specific pattern, and determines the degree of similarity between the second target image, and a second template including pattern information other than the specific pattern, or reducing the information on the specific information, or the first template.

2. The pattern matching device according to claim 1,
wherein the image processing unit extracts position candidates of the pattern matching by pattern matching the first target image, and selects a specific position from the candidates on the basis of the similarity determination.

3. The pattern matching device according to claim 2,
wherein the image processing unit selects a candidate having the highest degree of similarity from the candidates as the specific position.

4. The pattern matching device according to claim 1,
wherein the specific pattern is positioned in an upper layer than that of the other patterns displayed on the first target image.

5. The pattern matching device according to claim 1,
wherein the specific pattern has a higher signal strength than that of the other patterns displayed on the first target image.

6. The pattern matching device according to claim 1,
wherein the image processing unit produces the second target image with the exclusion of a region having a given width along an edge of the pattern included in the first target image, or with the reduction of information within the region in question.

7. The pattern matching device according to claim 6,
wherein the image processing unit excludes or reduces information in a region within a contour along the edge.

8. A computer program causing a computer to execute pattern matching on an image with the use of a template formed on the basis of design data or a picked-up image,
wherein the program causes the computer to execute the pattern matching on a first target image with the use of a first template including a plurality of different patterns, create a second target image with the exclusion of information on a region including a specific pattern among a plurality of patterns from the first target image, or with the reduction of the information on the specific pattern, and determine the degree of similarity between the second target image, and a second template including pattern information other than the specific pattern, or reducing the information on the specific information, or the first template.

9. The computer program according to claim 8,
wherein the program causes the computer to extract position candidates of the pattern matching by pattern matching the first target image, and select a specific position from the candidates on the basis of the similarity determination.

10. The computer program according to claim 9,
wherein the program causes the computer to select a candidate having the highest degree of similarity from the candidates as the specific position.

11. The computer program according to claim 8,
wherein the specific pattern is positioned in an upper layer than that of the other patterns displayed on the first target image.

12. The computer program according to claim 8,
wherein the specific pattern has a higher signal strength than that of the other patterns displayed on the first target image.

13. The computer program according to claim 8,
wherein the program causes the computer to produce the second target image with the exclusion of a region having a given width along an edge of the pattern included in the first target image, or with the reduction of information within the region in question.

14. The computer program according to claim 13,
wherein the program causes the computer to exclude or reduce information in a region within a contour along the edge.
